(19) United States
(12) Patent Application Publication
(10) Pub. No.: US 2019/0073671 A1
(43) Pub. Date: Mar. 7, 2019

(54) PAYMENT AUTHENTICATION METHOD, APPARATUS AND SYSTEM FOR ONBOARD TERMINAL

(71) Applicant: Alibaba Group Holding Limited, Grand Cayman, KY (US)

(72) Inventors: Qiang Fang, Hangzhou (CN); Chao Duan, Hangzhou (CN)

(21) Appl. No.: 16/184,942

(22) Filed: Nov. 8, 2018

Related U.S. Application Data
(63) Continuation of application No. PCT/CN2017/079867, filed on Apr. 10, 2017.

(30) Foreign Application Priority Data
May 9, 2016 (CN) 201610302680.1

(51) Int. Cl. G06Q 20/40; H04L 9/32; H04L 29/06

(52) U.S. Cl. CPC G06Q 20/401; G06Q 2220/00; H04L 63/0823; H04L 9/3263

(57) ABSTRACT

A method applied to an onboard terminal including receiving a payment authentication request sent by a server, and forwarding the payment authentication request to a user device having an established communication connection, the payment authentication request including a user identifier; receiving encrypted payment certification information responded by the user device and sending the encrypted payment certification information to the server, the encrypted payment certification information including the user identifier and a user device identifier; and receiving a certification result sent by the server and performing payment processing according to the certification result, the certification result indicating whether there is a binding relationship between the user identifier and the user device identifier. The present disclosure solves a technical problem of poor payment security in an existing mobile payment technology applied to onboard terminals.

### CROSS REFERENCE TO RELATED PATENT APPLICATIONS

This application claims priority to and is a continuation of PCT Patent Application No. PCT/CN2017/079867, filed on 10 Apr. 2017, which claims priority to Chinese Patent Application No. 201610302680.1 filed on 9 May 2016 and entitled “PAYMENT AUTHENTICATION METHOD, APPARATUS AND SYSTEM FOR ONBOARD TERMINAL”, which are incorporated herein by reference in their entirety.

### TECHNICAL FIELD

The present disclosure relates to the field of mobile payment, and, more particularly, to payment authentication methods, apparatuses and systems for onboard terminals.

### BACKGROUND

With the rapid development of Internet technologies, Internet payment has become an indispensable part of people's daily life. At present, mainstream Internet payment methods mainly include PC terminals, mobile terminals and so on. At present, the PC terminals mainly provide Internet payment services by means of Web. The PC terminals use browsers as tools for user interactions, and adopt payment applications in browser/server (B/S) architecture. After a user submits an order through a merchant website, the merchant website is redirected to a website of a payment institution, and the payment institution initiates an authentication request to the user. After the user provides authentication information, a server terminal performs verification, completes the authentication process, and then completes the transaction. The mobile terminals mainly provide Internet payment services by means of application programs, and adopt payment applications in client/server (C/S) architecture. After a user confirms an order through an application program of a merchant, the application program of the merchant is automatically redirected to a payment application program, and the payment application program directly initiates an authentication request to the user. After the user provides authentication information, a server terminal performs verification, and completes the authentication process and the transaction.

Recently, onboard terminals have also begun to use Internet payment services. At present, the process of transaction authentication for the onboard terminals is the same as that of the mobile terminals. Existing Bluetooth payment verification systems and methods for Bluetooth headsets and mobile phones generally adopt a manner of obtaining IDs of the Bluetooth headsets directly without encrypting and signing identification information of Bluetooth devices, and transmitting device IDs in a plain text manner. There is a risk that the device IDs could be stolen and tampered with, which will affect the payment security.

In conclusion, the existing mobile payment technology applied to onboard terminals has the problem of poor payment security.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term ““technique(s) or technical solution(s)” for instance, may refer to apparatus(s), system(s), method(s) and/or computer-readable instructions as permitted by the context above and throughout the present disclosure.

The present disclosure provides payment authentication methods, apparatuses and systems for onboard terminals to solve the technical problem of poor payment security in an existing mobile payment technology applied to the onboard terminals.

The present disclosure discloses a payment authentication method for an onboard terminal, including:

receiving a payment authentication request sent by a server, and forwarding the payment authentication request to a user device having an established communication connection, the payment authentication request including a user identifier;

receiving encrypted payment certification information responded by the user device and sending the encrypted payment certification information to the server, the encrypted payment certification information including the user identifier and a user device identifier; and receiving a certification result sent by the server and performing payment processing according to the certification result, the certification result indicating whether there is a binding relationship between the user identifier and the user device identifier.

Further, the method further includes:

acquiring the user device identifier, and encrypting the user device identifier and the user identifier; and

sending the encrypted user device identifier and the encrypted user identifier to the server, so that the server establishes a binding relationship between the user device identifier and the user identifier.

Further, the step of acquiring the user device identifier includes:

sending a binding request to the user device; and

receiving a binding response sent by the user device, the binding response including the user device identifier.

Further, the encrypted payment certification information is obtained by the user device by encrypting payment certification information using a private key certificate, wherein the payment certification information is generated by the user device in response to the payment authentication request.

Further, after the step of sending the encrypted user device identifier and the encrypted user identifier to the server, the method further includes:

receiving the private key certificate encrypted and sent by the server, the private key certificate being generated by the server according to the user device identifier and the user identifier; and

obtaining the private key certificate by decryption, and sending the private key certificate to the user device.

The present disclosure further discloses a payment authentication method for an onboard terminal, including:

receiving a payment authentication request sent by an onboard terminal having an established communication connection, the payment authentication request including a user identifier;

generating encrypted payment certification information in response to the payment authentication request, the encrypted payment certification information including the user identifier and a user device identifier; and

sending the encrypted payment certification information to a server through an onboard terminal, so that the server certifies whether there is a binding relationship between the user identifier and the user device identifier.

Further, the step of generating encrypted payment certification information in response to the payment authentication request further includes:

generating payment certification information in response to the payment authentication request; and

encrypting the payment certification information using a private key certificate to generate the encrypted payment certification information.

Further, the method further includes:

receiving a binding request sent by the onboard terminal, and sending the user device identifier to the onboard terminal in response to the binding request to allow the onboard terminal to send the encrypted user device identifier and the encrypted user identifier to the server, so that the server decrypts the encrypted user device identifier and the encrypted user identifier to generate the private key certificate and sends the encrypted private key certificate to the onboard terminal; and

receiving the decrypted private key certificate sent by the onboard terminal.

The present disclosure further discloses a payment authentication method for an onboard terminal, including:

sending a payment authentication request to a user device through an onboard terminal, the payment authentication request including a user identifier;

receiving encrypted payment certification information sent by the user device through the onboard terminal, the encrypted payment certification information being generated in response to the payment authentication request and including the user identifier and a user device identifier; and

decrypting the encrypted payment certification information, certifying whether there is a binding relationship between the user identifier and the user device identifier, and sending the certification result to the onboard terminal.

Further, the method further includes:

receiving and decrypting the encrypted user device identifier and the encrypted user identifier which are sent by the onboard terminal; and

establishing a binding relationship between the user device identifier and the user identifier.

Further, the encrypted payment certification information is obtained by the user device by encrypting the payment certification information using a private key certificate, wherein the payment certification information is generated by the user device in response to the payment authentication request.

Further, after the step of establishing a binding relationship between the user device identifier and the user identifier, the method further includes:

generating a private key certificate according to the user device identifier and the user identifier; and

encrypting the private key certificate and sending the encrypted private key certificate to the onboard terminal, so that the onboard terminal obtains the private key certificate by decryption and sends the private key certificate to the user device.

The present disclosure further discloses an onboard terminal for onboard terminal payment authentication, including:

a first communication module configured to receive a payment authentication request sent by a server, the payment authentication request including a user identifier;

a second communication module configured to forward the payment authentication request to a user device having an established communication connection; and receive encrypted payment certification information responded by the user device, the encrypted payment certification information including the user identifier and a user device identifier;

the first communication module further configured to send the encrypted payment certification information to the server; and receive a certification result sent by the server, the certification result indicating whether there is a binding relationship between the user identifier and the user device identifier; and

a processing module configured to perform payment processing according to the certification result.

Further, the onboard terminal further includes:

an acquiring module configured to acquire the user device identifier;

an encryption module configured to encrypt the user device identifier and the user identifier; and

the first communication module further configured to send the encrypted user device identifier and the encrypted user identifier to the server, so that the server establishes a binding relationship between the user device identifier and the user identifier.

Further, the acquiring module is, for example, configured to:

send a binding request to the user device through the second communication module; and

receive, through the second communication module, a binding response sent by the user device, the binding response including the user device identifier.

Further, the encrypted payment certification information is obtained by the user device by encrypting payment certification information using a private key certificate, wherein the payment certification information is generated by the user device in response to the payment authentication request.

Further, the first communication module is further configured to receive the private key certificate encrypted and sent by the server, the private key certificate being generated by the server according to the user device identifier and the user identifier; and

the onboard terminal further includes:

a decryption module configured to obtain the private key certificate by decryption; and

the second communication module further configured to send the private key certificate to the user device.

The present disclosure further discloses a user device for onboard terminal payment authentication, including:

a receiving module configured to receive a payment authentication request sent by an onboard terminal having an established communication connection, the payment authentication request including a user identifier;

a generation module configured to generate encrypted payment certification information in response to the payment authentication request, the encrypted payment certification information including the user identifier and a user device identifier; and

a sending module configured to send the encrypted payment certification information to a server through an onboard terminal, so that the server certifies whether there is a binding relationship between the user identifier and the user device identifier.

Further, the generation module includes:

a generation unit configured to generate payment certification information in response to the payment authentication request; and

an encryption unit configured to encrypt the payment certification information using a private key certificate to generate the encrypted payment certification information.

Further, the receiving module is further configured to receive a binding request sent by the onboard terminal;

the sending module is further configured to send the user device identifier to the onboard terminal in response to the binding request to allow the onboard terminal to send the encrypted user device identifier and the encrypted user identifier to the server, so that the server decrypts the encrypted user device identifier and the encrypted user identifier to generate the private key certificate and sends the encrypted private key certificate to the onboard terminal; and

the receiving module is further configured to receive the decrypted private key certificate sent by the onboard terminal.

The present disclosure further discloses a server for onboard terminal payment authentication, including:

a sending module configured to send a payment authentication request to a user device through an onboard terminal, the payment authentication request including a user identifier;

a receiving module configured to receive encrypted payment certification information sent by the user device through the onboard terminal, the encrypted payment certification information being generated in response to the payment authentication request and including the user identifier and a user device identifier;

a first decryption module configured to decrypt the encrypted payment certification information;

a certification processing module configured to certify whether there is a binding relationship between the user identifier and the user device identifier; and

the sending module further configured to send the certification result to the onboard terminal.

Further, the receiving module is further configured to receive the encrypted user device identifier and the encrypted user identifier which are sent by the onboard terminal; and

the apparatus further includes:

a second decryption module configured to decrypt the encrypted user device identifier and the encrypted user identifier; and

an establishing module configured to establish a binding relationship between the user device identifier and the user identifier.

Further, the encrypted payment certification information is obtained by the user device by encrypting the payment certification information using a private key certificate, wherein the payment certification information is generated by the user device in response to the payment authentication request.

Further, the server further includes:

a generation module configured to generate a private key certificate according to the user device identifier and the user identifier;

an encryption module configured to encrypt the private key certificate; and

the sending module further configured to send the encrypted private key certificate to the onboard terminal, so that the onboard terminal obtains the private key certificate by decryption and sends the private key certificate to the user device.

The present disclosure further discloses a system for onboard terminal payment authentication, including: the onboard terminal as described above, the user device as described above and the server as described above.

Compared with the conventional techniques, the present disclosure obtains the following technical effects:

According to the payment authentication method, apparatus and system for an onboard terminal in the present disclosure, a user device identifier and a user identifier are acquired, the user device identifier and the user identifier are encrypted on an onboard terminal, and an encrypted file is transmitted to a server. The encrypted file is decrypted in the server to generate a private key certificate of the user device and establish a binding relationship between the user device identifier and the user identifier. The private key certificate is encrypted and then transmitted to the onboard terminal and is decrypted on the onboard terminal. The decrypted private key certificate is stored in a trusted environment of a Bluetooth device. Payment certification information including the user device identifier and the user identifier is encrypted using the private key certificate, and the encrypted user device identifier and the encrypted user identifier are sent to the server, so that the server verifies whether there is a binding relationship between the user device identifier and the user identifier and then performs payment processing, which solves the problem of a complicated payment process and poor payment security in an existing mobile payment technology applied to onboard terminals. All files are transmitted in an encrypted manner in the process of acquiring the private key certificate, which improves the security of payment authentication. In the payment process of the onboard terminal, it is unnecessary for a motor vehicle driver to perform excessive operations, and the payment process is simple, thus guaranteeing the driver's safety and improving user's payment experience.

### BRIEF DESCRIPTION OF THE DRAWINGS

The accompanying drawings described here are used to provide further understanding of the present disclosure, and constitute a part of the present disclosure. Example embodiments of the present disclosure are used to explain the present disclosure, and do not improperly limit the present disclosure. In the drawings:

FIG. 1 is a structural block diagram of a system according to Example embodiment 1 of the present disclosure;

FIG. 2 is a structural block diagram according to Example embodiment 2 of the present disclosure;

FIG. 3 is another structural block diagram according to Example embodiment 2 of the present disclosure;

FIG. 4 is still another structural block diagram according to Example embodiment 2 of the present disclosure;

FIG. 5 is a structural block diagram according to Example embodiment 3 of the present disclosure;

FIG. 6 is another structural block diagram according to Example embodiment 3 of the present disclosure;

FIG. 7 is a structural block diagram according to Example embodiment 4 of the present disclosure;

FIG. 8 is another structural block diagram according to Example embodiment 4 of the present disclosure;

FIG. 9 is still another structural block diagram according to Example embodiment 4 of the present disclosure;

FIG. 10 is a flowchart of a method according to Example embodiment 2 of the present disclosure;

FIG. 11 is a flowchart of another method according to Example embodiment 2 of the present disclosure;

FIG. 12 is a flowchart of still another method according to Example embodiment 2 of the present disclosure;

FIG. 13 is a flowchart of a method according to Example embodiment 3 of the present disclosure;

FIG. 14 is a flowchart of another method according to Example embodiment 3 of the present disclosure;

FIG. 15 is a flowchart of still another method according to Example embodiment 3 of the present disclosure;

FIG. 16 is a flowchart of a method according to Example embodiment 4 of the present disclosure;

FIG. 17 is a flowchart of another method according to Example embodiment 4 of the present disclosure;

FIG. 18 is a flowchart of still another method according to Example embodiment 4 of the present disclosure;

FIG. 19 is a schematic diagram of an operating method according to Example embodiment 5 of the present disclosure; and

FIG. 20 is a schematic diagram of another operating method according to Example embodiment 5 of the present disclosure.

### DETAILED DESCRIPTION

Implementation manners of the present disclosure will be described below in detail with reference to the accompanying drawings and example embodiments, whereby implementation processes of how the present disclosure uses technical means to solve the technical problem and achieve technical effects may be fully understood and implemented accordingly.

For example, certain terms are used in the specification and the claims to refer to specific components. Those skilled in the art should understand that hardware manufacturers may name the same component using different terms. The specification and the claims do not distinguish components by name differences, but by functional differences between the components as criteria. If “include” as mentioned in the entire specification and claims is an open term, it should be interpreted as “include, but not limited to.” “Substantially” means that, within an acceptable error range, those skilled in the art may solve the technical problem and basically achieves the technical effect within a certain error range. In addition, the term “coupling” or “electrical connection” here contains any direct and indirect means of electrical coupling. Therefore, if it is described in the text that a first apparatus is coupled to a second apparatus, it represents that the first apparatus may be directly electrically coupled to the second apparatus or indirectly electrically coupled to the second apparatus through another apparatus or coupling means. The subsequent descriptions of the specification are example implementation manners of implementing the present disclosure, but the description is intended to clarify the general principle of the present disclosure and is not intended to limit the scope of the present disclosure. The protection scope of the present disclosure should be subject to the scope as defined in the appended claims.

It should be further noted that the terms “include” and “comprise” or any other variations intend to cover non-exclusive inclusion, so that a process, method, commodity or system including a series of elements not only include the elements, but also include other elements not explicitly listed, or also include elements inherent to the process, method, commodity or system. In the absence of more limitations, the element defined by the expression “including one . . . ” do not exclude that the process, method, commodity or system including the element also has another identical element.

### Example Embodiment 1

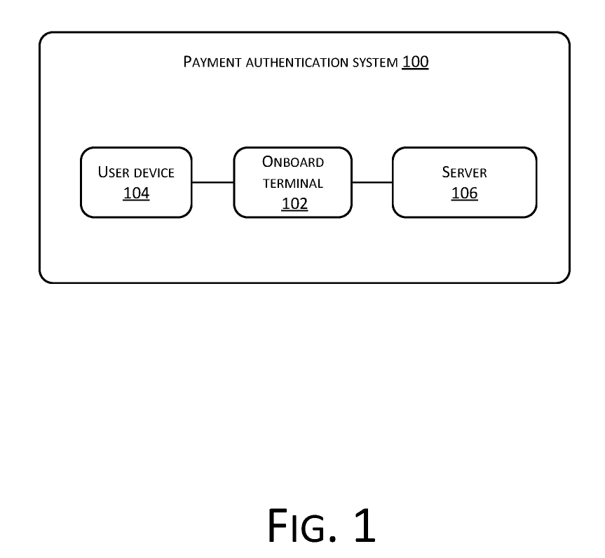

Referring to FIG. 1, a structural block diagram of a payment authentication system for an onboard terminal according to Example embodiment 1 of the present disclosure is shown. The payment authentication system 100 for an onboard terminal in this example embodiment includes an onboard terminal 102, a user device 104 and a server 106.

Here, the onboard terminal 102 refers to a terminal device mounted on a vehicle, which has a function of connecting to the Internet, has a network connection relationship with the server 106, and may establish a communication connection relationship with the user device 104. It should be further noted that the “vehicle” as referred to here includes, but is not limited to, internal combustion engine vehicles or motorcycles, electric vehicles or motorcycles, electric bicycles, electric balance vehicles, remote-controlled vehicles, small aircrafts (e.g., unmanned aircrafts, small manned aircrafts, remote-controlled aircrafts), and various variations. Correspondingly, an onboard instruction input device, an onboard processor and an onboard display device in the vehicle refer to a related input device, a related processor and a related display device that are carried in the corresponding vehicle. In other words, “onboard” may be simply understood as the meaning of being carried in the vehicle.

The user device 104 is a mobile device that may have a communication connection relationship with the onboard terminal 102. It should be pointed out that the communication connection may be a typical Bluetooth communication connection, and may also be another near field communication connection, e.g., a WIFI connection, an NFC connection, an infrared connection, or the like. It is conceivable that all manners having near field communication connections are appropriate for the present disclosure. In addition, the user device 104 needs to have a storage module, that is, it needs to have a storage function. Typically, the user device 104 may include a smart phone, a tablet computer, a Bluetooth headset having a storage function, or the like.

The server 106 corresponds to an application program installed on the onboard terminal 20. If a shopping application “TMALL” is installed on the onboard terminal 20, the server 106 corresponds to a backend user server of TMALL. It should be noted that the server 106 has a database for storing user information.

At present, payment authentication mainly includes transaction password, fingerprint identification, SMS verification code, OTP token, and so on. The transaction password authentication is that a user provides a transaction password to a server when registering in a payment application. The user manually enters the transaction password each time payment is made, and a server terminal compares the transaction password to complete user authentication. The transaction password is a user authentication manner used more frequently at present. At present, the fingerprint identification is mainly used for payment authentication on mobile terminals. A user registers fingerprint information on a mobile device that supports fingerprint identification. After a payment application enables a fingerprint verification function, the user enters the fingerprint information through a fingerprint identification device each time payment is made, and the payment application sends the fingerprint information to a local trusted environment and compares the fingerprint information with a fingerprint template stored in the trusted environment to realize the authentication. The SMS verification code adopts a manner of one-time pad, and sends to a server terminal, via a SMS, a verification code generated by the server terminal each time a client terminal initiates a transaction request. After subjectively identifying the verification code, the user enters the verification code into the payment application, and the payment application sends the verification code to the server terminal for comparison to complete user authentication. The OTP token adopts a manner of one-time pad, and sends to a server terminal, via an OTP hardware device or application program, a verification code generated by the server terminal each time a client terminal initiates a transaction request. After subjectively identifying the verification code, the user enters the verification code into the payment application, and the payment application sends the verification code to the server terminal for comparison to complete user authentication.

However, several existing major identity authentication methods, such as transaction password, fingerprint identification, SMS verification code and OTP token, have been widely applied in the process of payment at PC terminals and mobile terminals. However, the payment at onboard terminals is different from the payment at the PC terminals and the mobile terminals in that: the transaction password, the SMS verification code, the OTP token and other identity authentication methods require the user to interact with payment terminals complicatedly and require the user to identify and input identity authentication information, which will attract too much attention from the driver for an onboard payment scenario, leading to dangerous driving. The fingerprint identification method does not require a driver to identify and input the identity authentication information, and only requires the user to touch the fingerprint identification device with a finger. However, the scenario of the onboard terminal is different from the scenario of the mobile terminal in that: the onboard terminal does not need to carry out user identity authentication frequently, and thus it does not need a fingerprint identification device. At present, the onboard terminal does not carry any fingerprint identification device. That is, the existing payment authentication method is not suitable for onboard terminals to carry out payment services.

However, in the existing Bluetooth payment certification system and method for a Bluetooth headset and mobile phone, a Bluetooth payment certification module sends an instruction signal to the Bluetooth headset through a Bluetooth communication interface. An identification processor obtains the instruction signal and performs identification processing. If the instruction signal is an instruction of acquiring a headset ID, the identification processor obtains the headset ID from a memory and transmits the headset ID to a Bluetooth payment certification module. Such an authentication process also has the following security risk: in the data transmitted, the Bluetooth headset ID is transmitted in a plaintext manner and the transmission content is not signed, and information has a risk of being stolen and tampered in the transmission process. At present, it is not found that the Bluetooth headset has a secure storage unit of a trusted environment. Therefore, the existing Bluetooth headset device cannot guarantee secure storage of an issued certificate without adding a trusted environment, and there is a risk that the digital certificate will be stolen.

In short, the existing mobile payment technology, especially the mobile payment technology applied to onboard terminals has the problem of poor payment security.

According to the present disclosure, a user device identifier and a user identifier are acquired, the user device identifier and the user identifier are encrypted on an onboard terminal, an encrypted file is transmitted to a server, the encrypted file is decrypted in the server to generate a private key certificate of the user device and establish a binding relationship between the user device identifier and the user identifier, the private key certificate is encrypted and then transmitted to the onboard terminal and is decrypted on the onboard terminal, and the decrypted private key certificate is stored in a trusted environment of a Bluetooth device. Payment certification information including the user device identifier and the user identifier is encrypted using the private key certificate, and the encrypted user device identifier and the encrypted user identifier are sent to the server, so that the server verifies whether there is a binding relationship between the user device identifier and the user identifier and then performs payment processing, which solves the problem of a complicated payment process and poor payment security in an existing mobile payment technology applied to onboard terminals. All files are transmitted in an encrypted manner in the process of acquiring the private key certificate, which improves the security of payment authentication. In the payment process of the onboard terminal, it is unnecessary for a motor vehicle driver to perform excessive operations, and the payment process is simple, thus guaranteeing the driver's safety and improving user's payment experience.

The above example embodiment simply introduces the onboard terminal 102, the user device 104 and the server 106 from the level of the payment authentication system for an onboard terminal. The following example embodiments (Example embodiment 2, Example embodiment 3 and Example embodiment 4) describe modular structures and execution methods of the onboard terminal 102, the user device 104 and the server 106 in detail respectively.

### Example Embodiment 2

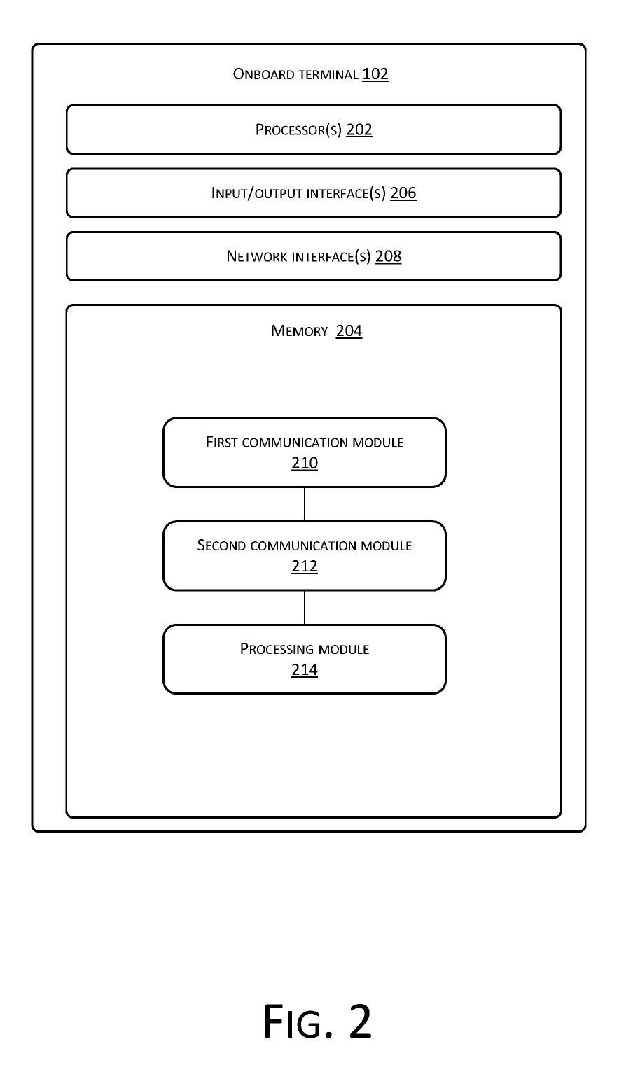

Referring to FIG. 2, a structural block diagram of an onboard terminal for onboard terminal payment authentication according to Example embodiment 2 of the present disclosure is shown. The onboard terminal 102 includes one or more processor(s) 202 or data processing unit(s) and memory 204. The onboard terminal 102 may further include one or more input/output interface(s) 206 and one or more network interface(s) 208.

The memory is an example of computer-readable media. The computer-readable media include non-volatile and volatile media as well as movable and non-movable media, and may implement information storage by means of any method or technology. Information may be a computer-readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition of this text, the computer-readable medium or media do not include transitory media, such as a modulated data signal and a carrier.

The memory 104 may store therein a plurality of modules or units including a first communication module 210, a second communication module 212, and a processing module 214.

The first communication module 210 is configured to receive a payment authentication request sent by a server, the payment authentication request including a user identifier.

The second communication module 212 is configured to forward the payment authentication request to a user device having an established communication connection; and receive encrypted payment certification information responded by the user device, the encrypted payment certification information including the user identifier and a user device identifier.

The first communication module 210 is further configured to send the encrypted payment certification information to the server; and receive a certification result sent by the server, the certification result indicating whether there is a binding relationship between the user identifier and the user device identifier.

The processing module 214 is configured to perform payment processing according to the certification result.

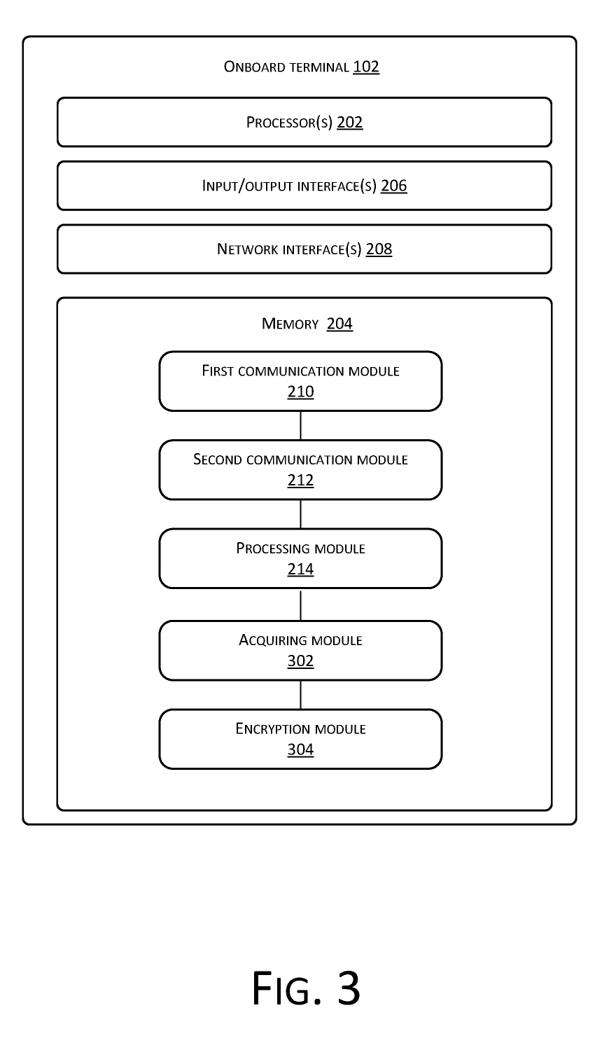

In another example embodiment of the present disclosure, referring to FIG. 3, another structural block diagram of an onboard terminal for onboard terminal payment authentication according to Example embodiment 2 of the present disclosure is shown. The onboard terminal 102 further includes an acquiring module 302 and an encryption module 304 stored in the memory 104.

The acquiring module 302 is configured to acquire the user device identifier.

The encryption module 304 is configured to encrypt the user device identifier and the user identifier.

The first communication module 210 is further configured to send the encrypted user device identifier and the encrypted user identifier to the server, so that the server establishes a binding relationship between the user device identifier and the user identifier.

In addition, the acquiring module 302 is, for example, configured to send a binding request to the user device through the second communication module 212; and

receive, through the second communication module 212, a binding response sent by the user device, the binding response including the user device identifier.

Moreover, the encrypted payment certification information is obtained by the user device by encrypting payment certification information using a private key certificate, wherein the payment certification information is generated by the user device in response to the payment authentication request.

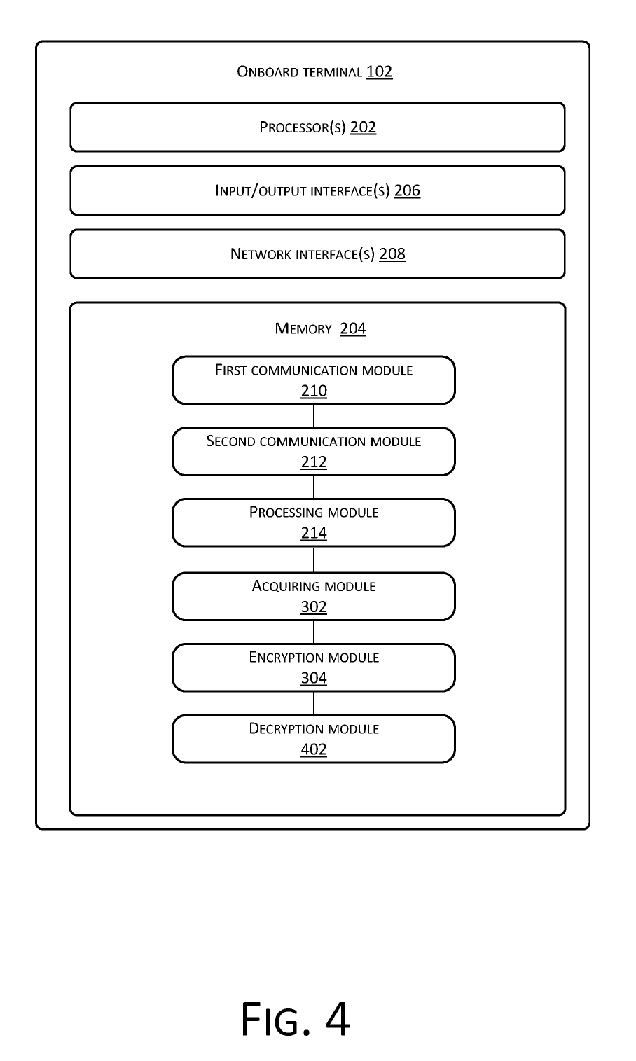

In another example embodiment of the present disclosure, referring to FIG. 4, still another structural block diagram of an onboard terminal for onboard terminal payment authentication according to Example embodiment 2 of the present disclosure is shown. The first communication module 210 is further configured to receive the private key certificate encrypted and sent by the server, the private key certificate being generated by the server according to the user device identifier and the user identifier.

The onboard terminal 102 further includes a decryption module 402 stored in the memory 104. The decryption module 402 is configured to obtain the private key certificate by decryption.

The second communication module 212 is further configured to send the private key certificate to the user device.

The above is an apparatus example embodiment of an onboard terminal for onboard terminal payment authentication. The onboard terminal is further described in the following in combination with the process example embodiment that may be performed at the onboard terminal 102.

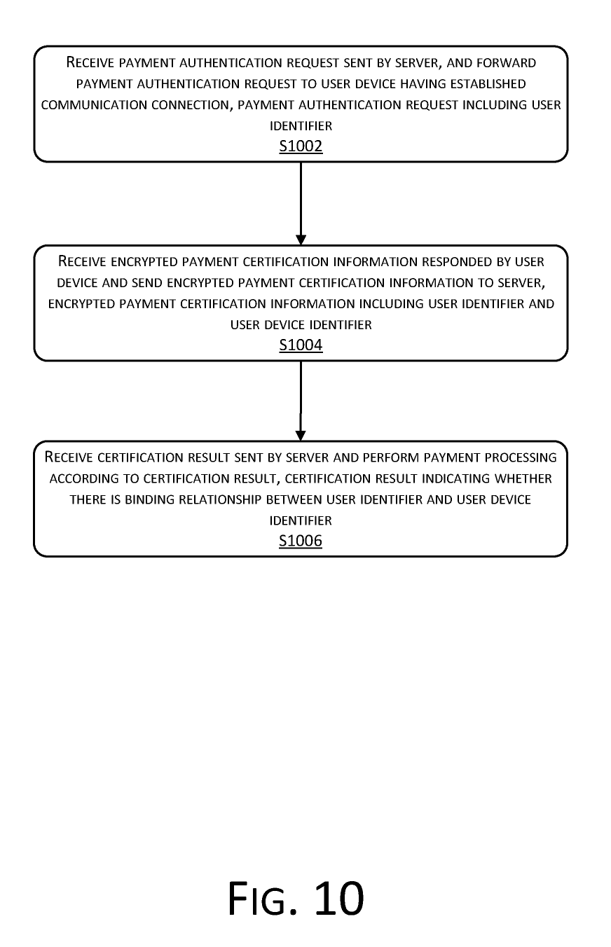

Referring to FIG. 10 to FIG. 12, method flowcharts of a payment authentication method for an onboard terminal performed at the onboard terminal 102 according to this example embodiment are shown respectively.

Referring to FIG. 10, the payment authentication method that may be performed by the onboard terminal 102 includes the following steps:

Step S1002: A payment authentication request sent by a server is received, and the payment authentication request is forwarded to a user device having an established communication connection, the payment authentication request including a user identifier.

Step S1004: Encrypted payment certification information responded by the user device is received and sent to the server, the encrypted payment certification information including the user identifier and a user device identifier.

Step S1006: A certification result sent by the server is received and payment processing is performed according to the certification result, the certification result indicating whether there is a binding relationship between the user identifier and the user device identifier.

For example, in step S1004, the first communication module 210 receives a payment authentication request sent by the server, and forwards the payment authentication request through the second communication module 212 to a user device having an established communication connection. The payment authentication request includes a user identifier. Here, prior to step S1004, the onboard terminal 102 needs to call an Application Program Interface (API) of an application (such as TMALL described above) installed on the onboard terminal 102 to acquire a user identifier, i.e., a user ID, that is logged in to the application. Then, a payment transaction request is sent to the server through the onboard terminal 102, that is, information of the transaction request and the user identifier are sent to the server. The server needs to confirm the information of the transaction request when receiving the information of the transaction request and the user identifier, and after confirmation, the server initiates a payment authentication request to the onboard terminal 102. That is, the payment authentication request includes the user identifier. However, it is conceivable that the payment authentication request may also include the information of the transaction request. In addition, the manner of sending a payment transaction request to the server through the onboard terminal 102 may be obtained by a user touching a man-machine interaction interface of the onboard terminal 102 or obtained in another man-machine interaction manner, such as collecting a user interaction instruction by voice.

After the onboard terminal 102 receives the payment authentication request, first of all, it needs to be determined whether the user device has been connected to the onboard terminal 102. If the user device has been connected to the onboard terminal 102, the second communication module 212 forwards the payment authentication request to the user device. If the user device has not been connected to the onboard terminal 102, a binding connection request is sent to the user device and the user device is connected. After the user device is connected, the second communication module 212 forwards the payment authentication request to the user device. So far, step S1002 has been completed.

Following step S1002 as described above, in step S1004, first of all, the second communication module 212 receives encrypted payment certification information responded by the user device. The encrypted payment certification information includes the user identifier and a user device identifier. Then, the first communication module 210 sends the encrypted payment certification information to the server.

Here, the encrypted payment certification information is obtained by the user device by encrypting payment certification information using a private key certificate, wherein the payment certification information is generated by the user device in response to the payment authentication request. It should be noted that a private key certificate for encrypting the payment certification information is stored in the user device in the above situation. As for the situation where the private key certificate for encrypting the payment certification information is not stored in the user device, a method for acquiring the private key certificate will be described in detail below, the details of which are not described here. In addition, the method for generating the payment certification information by the user device in response to the payment authentication request includes: first acquiring information of the user identifier in the payment authentication request, or acquiring information of the transaction request; then calling a driver of the user device to acquire the user device identifier; and finally integrating the user device identifier and the user identifier (which may also include the information of the transaction request) to obtain the payment certification information. It is apparent that the payment certification information includes the user device identifier and the user identifier, and the encrypted payment certification information is obtained by encrypting the payment certification information using the private key certificate; therefore the encrypted payment certification information certainly includes the user identifier and the user device identifier.

After acquiring the encrypted payment certification information, the user device sends the encrypted payment certification information to the onboard terminal 102. That is, the second communication module 212 receives encrypted payment certification information responded by the user device. Then, the first communication module 210 sends the encrypted payment certification information to the server. That is, step S1004 is completed.

Following step S1004 as described above, in step S1006, first of all, the first communication module 210 receives a certification result sent by the server; and then, the processing module 214 performs payment processing according to the certification result. Here, the certification result indicates whether there is a binding relationship between the user identifier and the user device identifier, that is, whether the user identifier and the user device identifier are bound and kept on record in the server. The “bound and kept on record” means that the user identifier and the user device identifier have a binding relationship and have been kept on record in the server network.

For example, after receiving the encrypted payment certification information, first of all, the server needs to decrypt the encrypted payment certification information using a public key of the private key certificate, and acquire the user identifier and the user device identifier. It should be pointed out that the public key of the private key certificate is stored in the server as described above. As for the situation where the public key of the private key certificate is not stored in the server, a method for acquiring the public key of the private key certificate will be described in detail below, the details of which are not described here. Then, the server verifies whether there is a binding relationship between the user identifier and the user device identifier. For example, the user identifier and the user device identifier may be mapped and compared with user identifiers and user device identifiers that have been kept on record in a database of the server. If the user identifier and the user device identifier exist in the database of the server, and the user identifier and the user device identifier are also mapped in pair, it indicates that there is a binding relationship between the user identifier and the user device identifier. If the user identifier and the user device identifier do not exist in the database of the server, or the user identifier and the user device identifier are not mapped in pair, it indicates that there is no binding relationship between the user identifier and the user device identifier.

When there is no binding relationship between the user identifier and the user device identifier, the server sends a result of failed certification. The first communication module 210 receives the result of failed certification sent by the server, and the processing module 214 refuses to perform payment processing according to the result of failed certification, that is, the authentication fails.

When there is a binding relationship between the user identifier and the user device identifier, the server sends a result of successful certification. The first communication module 210 receives the result of successful certification sent by the server, and the processing module 214 allows performing payment processing according to the result of successful certification, that is, the authentication is successful. So far, step S1006 has been completed.

The above describes the situation where a binding relationship between the user device identifier and the user identifier is stored in the server, that is, there is no need to establish a binding relationship between the user device identifier and the user identifier in the server in the above authentication process. The situation where a binding relationship between the user device identifier and the user identifier needs to be established in the server in the authentication process is described in detail below:

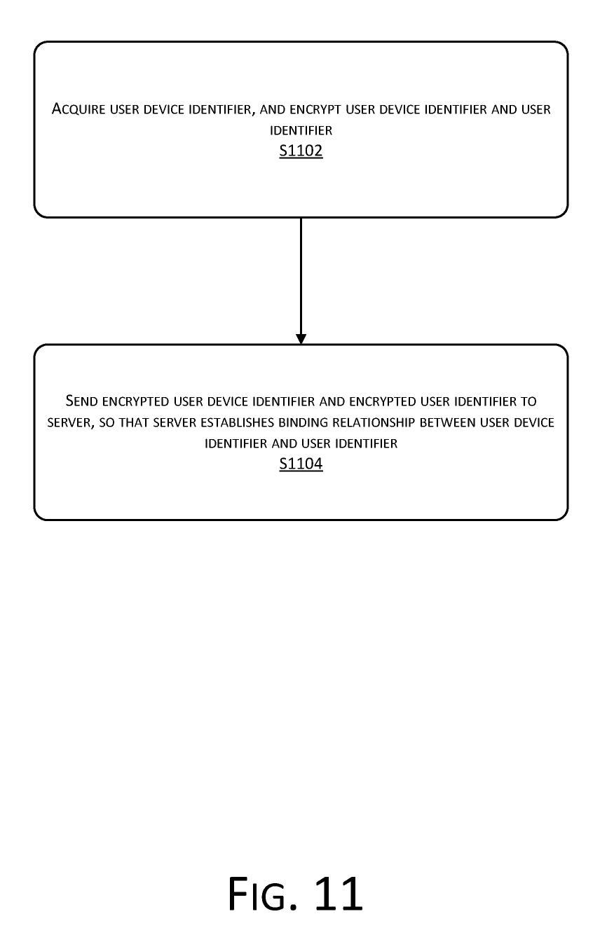

Referring to FIG. 11, the payment authentication method for the onboard terminal 102 further includes the following steps:

Step S1102: The user device identifier is acquired, and the user device identifier and the user identifier are encrypted.

Step S1104: The encrypted user device identifier and the encrypted user identifier are sent to the server, so that the server establishes a binding relationship between the user device identifier and the user identifier.

It should be pointed out that step S1102 and step S1104 may be performed in advance or performed temporarily when the binding relationship between the user device identifier and the user identifier needs to be verified. The specific timing sequence of step S1102 and step S1104 is not specifically limited in the present disclosure.

In step S1102, first of all, the acquiring module 302 acquires the user device identifier; and then the encryption module 304 encrypts the user device identifier and the user identifier.

Here, the method for acquiring the user device identifier by the acquiring module 302 includes: first of all, sending a binding request to the user device; and then receiving a binding response sent by the user device, the binding response including the user device identifier. For example, first of all, the acquiring module 302 is configured to send a binding request to the user device through the second communication module 212. After receiving the binding request, the user device is bound to the onboard terminal 102, acquires the user device identifier by calling a driver of the user device, and sends a binding response to the onboard terminal 102. The binding response includes the user device identifier. Then, the acquiring module receives, through the second communication module 212, the binding response sent by the user device, that is, acquires the user device identifier.

After the user device identifier is acquired, the encryption module 304 encrypts the user device identifier and the user identifier. Here, the encryption module 304 encrypts the user device identifier and the user identifier using a public key of the server pre-stored in the onboard terminal 102. The public key of the server may be pre-stored when the onboard terminal leaves the factory. So far, step S1102 has been completed.

Following step S1102 as described above, in step S1104, the first communication module 210 sends the encrypted user device identifier and the encrypted user identifier to the server. Here, the first communication module 210 sends the encrypted user device identifier and the encrypted user identifier to the server such that the server establishes a binding relationship between the user device identifier and the user identifier. For example, after receiving the encrypted user device identifier and the encrypted user identifier, the server needs to call a private key of the server to decrypt the encrypted user device identifier and the encrypted user identifier to acquire the user device identifier and the user identifier, bind the user device identifier to the user identifier and store the user device identifier and the user identifier in the server. That is, the server is made to establish a binding relationship between the user device identifier and the user identifier. So far, step S1104 has been completed.

The above points out that the encrypted payment certification information is obtained by the user device by encrypting payment certification information using a private key certificate, wherein the payment certification information is generated by the user device in response to the payment authentication request.

As described previously, a private key certificate for encrypting the payment certification information is stored in the user device in the above situation. As for the situation where the private key certificate for encrypting the payment certification information is not stored in the user device, the private key certificate needs to be acquired at first. A method for acquiring the private key certificate is described in detail below:

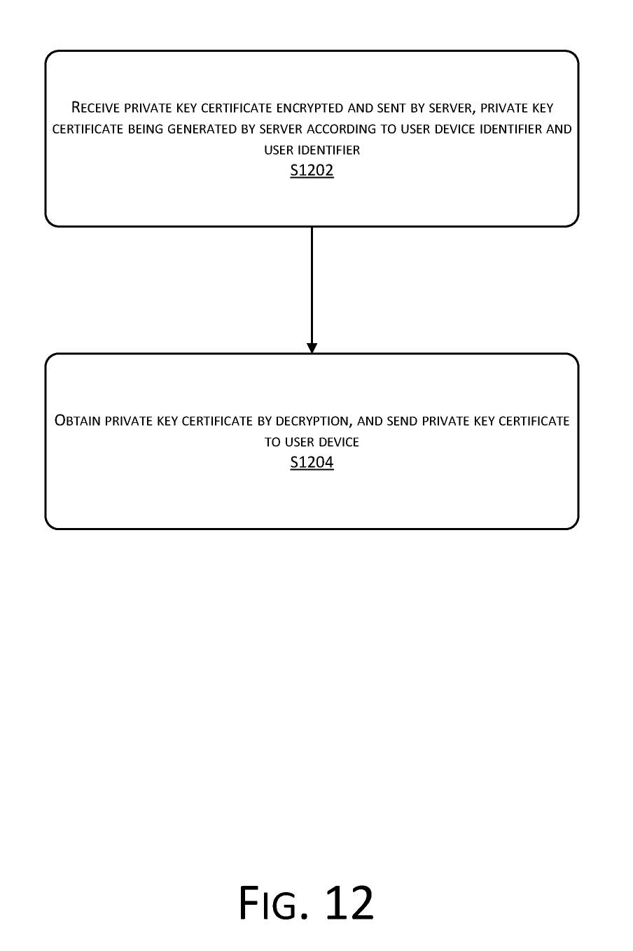

Referring to FIG. 12, after the step of sending the encrypted user device identifier and the encrypted user identifier to the server, the method further includes the following steps:

Step S1202: The private key certificate encrypted and sent by the server is received, the private key certificate being generated by the server according to the user device identifier and the user identifier.

Step S1204: The private key certificate is obtained by decryption, and the private key certificate is sent to the user device.

In step S1202, the first communication module 210 receives the private key certificate encrypted and sent by the server, the private key certificate being generated by the server according to the user device identifier and the user identifier. For example, a private key certificate of the user device is generated after the server acquires the user device identifier and the user identifier, and the private key certificate of the user device is stored in the server for decryption. In addition, the private key certificate of the user device is encrypted using a public key of the onboard terminal 102 when leaving the factory, and then the encrypted private key certificate of the user device is sent to the onboard terminal 102. Here, the public key of the onboard terminal 102 when leaving the factory may be obtained by the server by accessing the onboard terminal 102 via a network connection. That is, the server sends the encrypted private key certificate of the user device to the onboard terminal 102, and the first communication module 210 receives the private key certificate encrypted and sent by the server. So far, step S1202 has been completed.

Following step S1202 as described above, in step S1204, first of all, the decryption module 402 is configured to obtain the private key certificate by decryption; and then the second communication module 212 sends the private key certificate to the user device.

For example, the decryption module 402 decrypts the encrypted private key certificate of the user device using a private key stored when the onboard terminal 102 leaves the factory, and acquires the private key certificate of the user device. Then, the second communication module 212 sends the private key certificate to the user device. After receiving the private key certificate, the user device stores the private key certificate in a trusted environment of the user device. The trusted environment refers to a readable storage space. The user encrypts the payment certification information using the private key certificate stored in the trusted environment, to obtain the encrypted payment certification information. So far, step 114 has been completed.

### Example Embodiment 3

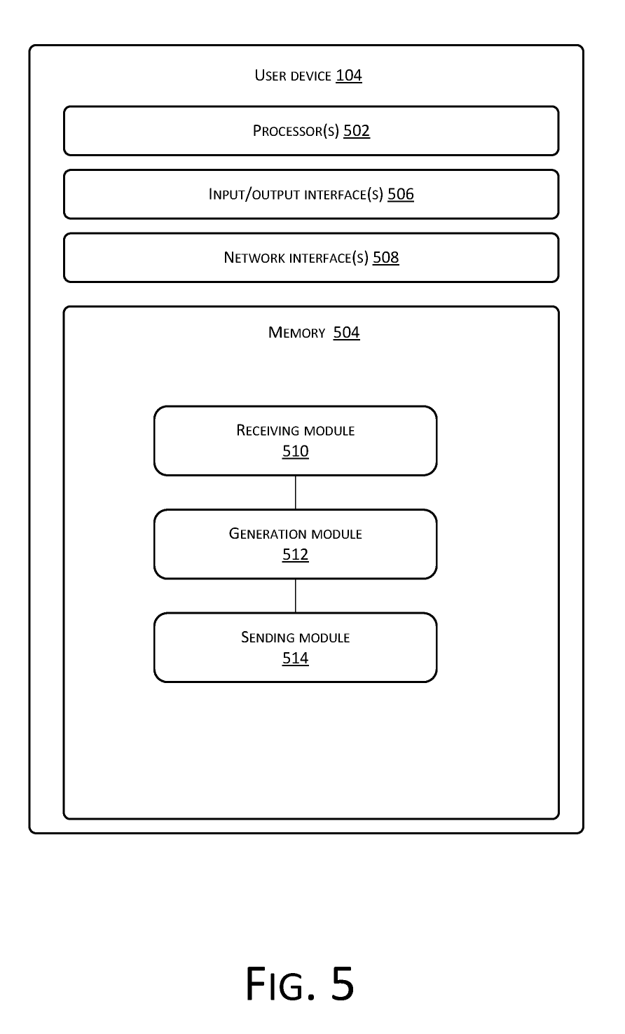

Referring to FIG. 5, a structural block diagram of a user device for onboard terminal payment authentication according to Example embodiment 3 of the present disclosure is shown. The user device 104 includes one or more processor(s) 502 or data processing unit(s) and memory 504. The user device 104 may further include one or more input/output interface(s) 506 and one or more network interface(s) 508. The memory is an example of computer-readable media.

The memory 504 may store therein a plurality of modules or units including a receiving module 510, a generation module 512 and a sending module 514.

The receiving module 510 is configured to receive a payment authentication request sent by an onboard terminal having an established communication connection, the payment authentication request including a user identifier.

The generation module 512 is configured to generate encrypted payment certification information in response to the payment authentication request, the encrypted payment certification information including the user identifier and a user device identifier.

The sending module 514 is configured to send the encrypted payment certification information to a server through an onboard terminal, so that the server certifies whether there is a binding relationship between the user identifier and the user device identifier.

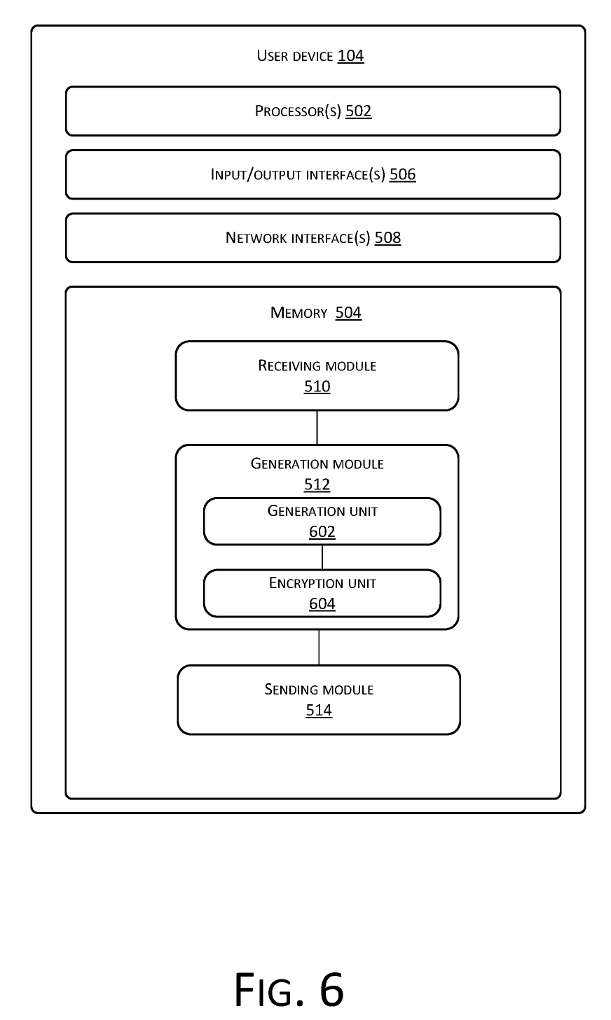

In another example embodiment of the present disclosure, referring to FIG. 6, another structural block diagram of an onboard terminal for onboard terminal payment authentication according to Example embodiment 3 of the present disclosure is shown. The generation module 512 further includes a generation unit 602 and an encryption unit 604.

The generation unit 602 is configured to generate payment certification information in response to the payment authentication request.

The encryption unit 604 is configured to encrypt the payment certification information using a private key certificate to generate the encrypted payment certification information.

In another example embodiment of the present disclosure, the receiving module 510 is further configured to receive a binding request sent by the onboard terminal;

the sending module 514 is further configured to send the user device identifier to the onboard terminal in response to the binding request to allow the onboard terminal to send the encrypted user device identifier and the encrypted user identifier to the server, so that the server decrypts the encrypted user device identifier and the encrypted user identifier to generate the private key certificate and sends the encrypted private key certificate to the onboard terminal; and

the receiving module 510 is further configured to receive the decrypted private key certificate sent by the onboard terminal.

An apparatus example embodiment of a user device 104 for onboard terminal payment authentication is described above. The user device for onboard terminal payment authentication is further described in the following in combination with the process example embodiment that may be performed at the user device 104.

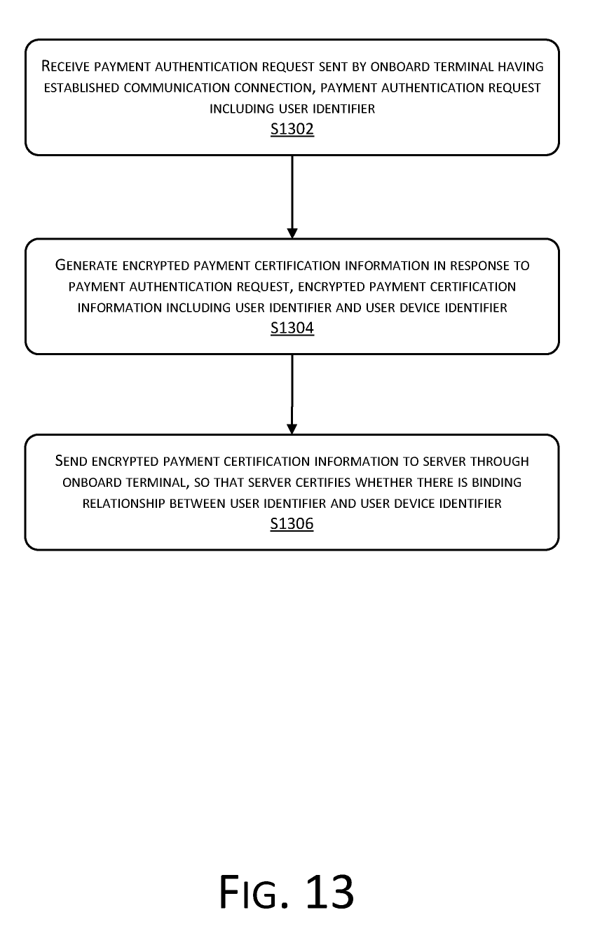

Referring to FIG. 13 to FIG. 15, method flowcharts of a payment authentication method for an onboard terminal performed at the user device 104 according to this example embodiment are shown respectively.

Referring to FIG. 13, the payment authentication method that may be performed by the user device 104 includes the following steps:

Step S1302: A payment authentication request sent by an onboard terminal having an established communication connection is received, the payment authentication request including a user identifier.

Step S1304: Encrypted payment certification information is generated in response to the payment authentication request, the encrypted payment certification information including the user identifier and a user device identifier.

Step S1306: The encrypted payment certification information is sent to a server through an onboard terminal, so that the server certifies whether there is a binding relationship between the user identifier and the user device identifier.

For example, in step S1302, the receiving module 510 receives the payment authentication request sent by the onboard terminal having an established communication connection, the payment authentication request including the user identifier. Here, the payment authentication request is sent by the onboard terminal. Reference may be made to Example embodiment 2 as described above for the method for acquiring the payment authentication request by the onboard terminal, the details of which are not described here.

Following step S1302 as described above, in step S1304, the generation module 512 generates the encrypted payment certification information in response to the payment authentication request, the encrypted payment certification information including the user identifier and the user device identifier.

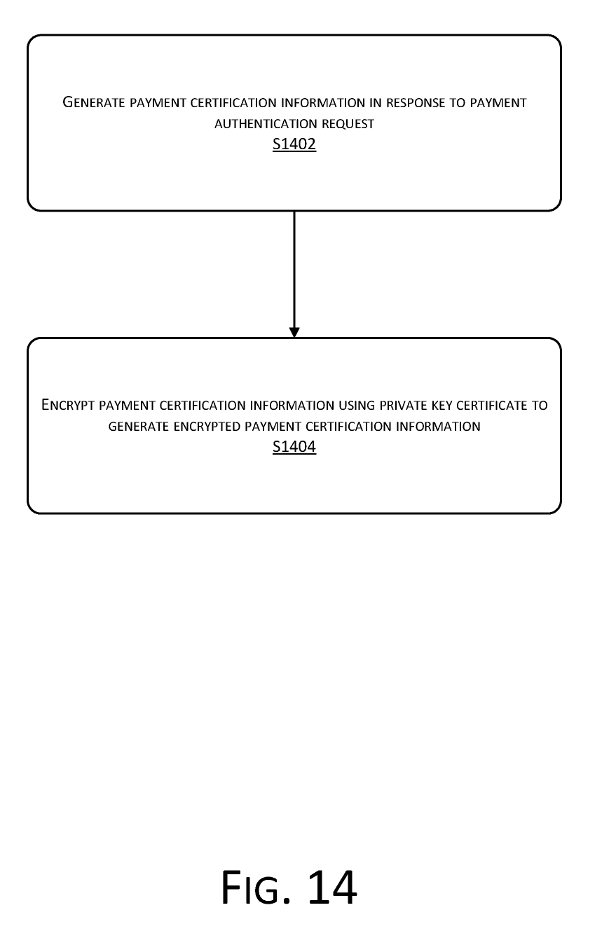

For example, referring to FIG. 14, step S1304 includes the following steps:

Step S1402: Payment certification information is generated in response to the payment authentication request.

Step S1404: The payment certification information is encrypted using a private key certificate to generate encrypted payment certification information.

For example, the generation unit 602 generates payment certification information in response to the payment authentication request.

The encryption unit 604 encrypts the payment certification information using a private key certificate to generate encrypted payment certification information.

Here, the user device 104 first calls a device driver to acquire the user device identifier, and then encrypts the user identifier and the user device identifier using the private key certificate stored in the user device. Reference may be made to Example embodiment 2 as described above for the specific method for generating payment certification information and the method for encrypting the payment certification information.

Following step S1304 as described above, in step S1306, the sending module 514 sends the encrypted payment certification information to the server through the onboard terminal, so that the server certificates whether there is a binding relationship between the user identifier and the user device identifier. Here, after acquiring the encrypted payment certification information, the user device 104 transmits the encrypted payment certification information to the server through the onboard terminal, so that the server certificates whether there is a binding relationship between the user identifier and the user device identifier. Reference may be made to Example embodiment 2 as described above for the manner in which the server certificates whether there is a binding relationship between the user identifier and the user device identifier. The details of the manner are not described here.

It is pointed out in the foregoing that the encrypted payment certification information is obtained by the user device 104 by encrypting the payment certification information using a private key certificate, wherein the payment certification information is generated by the user device in response to the payment authentication request. A private key certificate for encrypting the payment certification information is stored in the user device in the above situation. As for the situation where the private key certificate for encrypting the payment certification information is not stored in the user device, the private key certificate needs to be acquired at first. A method for acquiring the private key certificate is described in detail below:

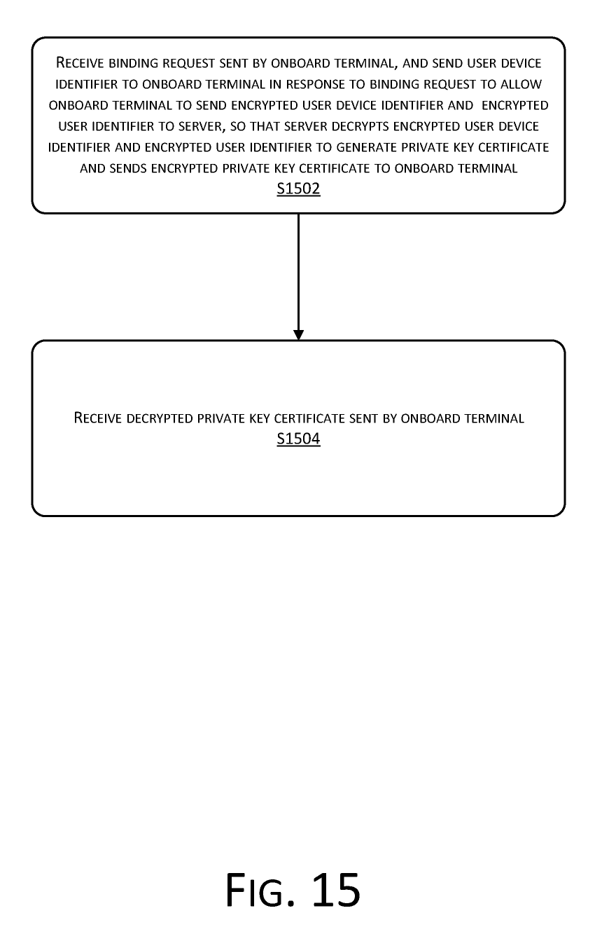

Referring to FIG. 15, in another example embodiment of the present disclosure, the method for acquiring the private key certificate by the user device 104 includes the following steps:

Step S1502: A binding request sent by the onboard terminal is received, and the user device identifier is sent to the onboard terminal in response to the binding request to allow the onboard terminal to send the encrypted user device identifier and the encrypted user identifier to the server, so that the server decrypts the encrypted user device identifier and the encrypted user identifier to generate the private key certificate and sends the encrypted private key certificate to the onboard terminal.

Step S1504: The decrypted private key certificate sent by the onboard terminal is received.

For example, in step S1502, first of all, the receiving module 510 receives a binding request sent by the onboard terminal, and connects and binds the user device 104 to the onboard terminal 102.

Then, the sending module 514 sends the user device identifier to the onboard terminal in response to the binding request to allow the onboard terminal to send the encrypted user device identifier and the encrypted user identifier to the server, so that the server decrypts the encrypted user device identifier and the encrypted user identifier to generate the private key certificate and sends the encrypted private key certificate to the onboard terminal.

Following step S1502 as described above, in step S1504, the receiving module 510 receives the decrypted private key certificate sent by the onboard terminal 102. After the private key certificate is received, the private key certificate is stored in a trusted environment of the user device. The trusted environment refers to a readable storage space. The user encrypts the payment certification information using the private key certificate stored in the trusted environment, to obtain the encrypted payment certification information.

It should be noted that reference may be made to the method in Example embodiment 2 for the method for acquiring the private key certificate of the user device, and reference may be made to the content in Example embodiment 2 for any unclear content in this example embodiment.

### Example Embodiment 4

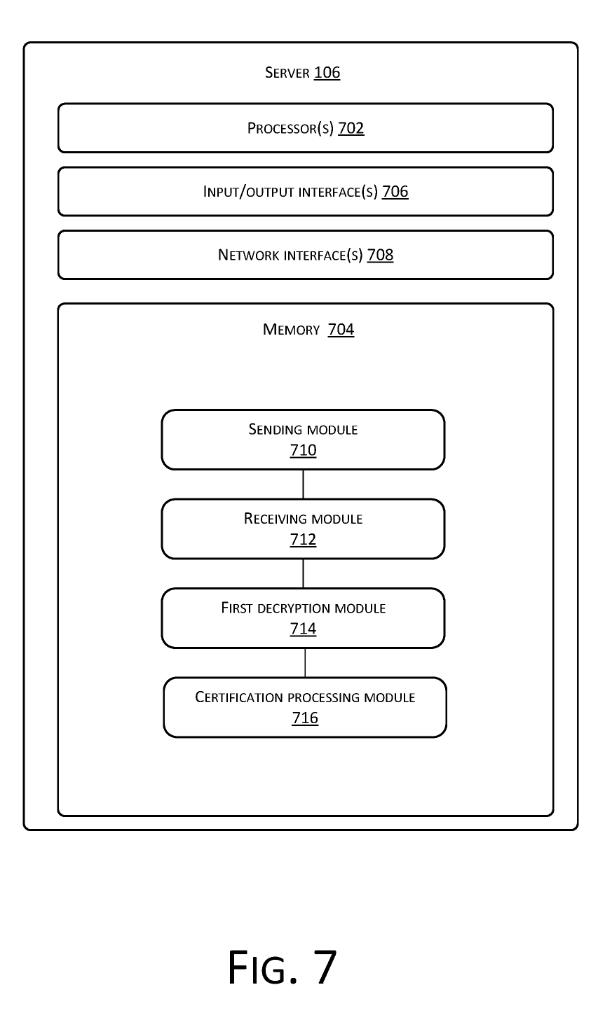

Referring to FIG. 7, a structural block diagram of a server for onboard terminal payment authentication according to Example embodiment 4 of the present disclosure is shown. The server 106 includes one or more processor(s) 702 or data processing unit(s) and memory 704. The server 106 may further include one or more input/output interface(s) 706 and one or more network interface(s) 708. The memory is an example of computer-readable media.

The memory 704 may store therein a plurality of modules or units including a sending module 710, a receiving module 712, a first decryption module 714 and a certification processing module 716.

The sending module 710 is configured to send a payment authentication request to a user device through an onboard terminal, the payment authentication request including a user identifier.

The receiving module 712 is configured to receive encrypted payment certification information sent by the user device through the onboard terminal, the encrypted payment certification information being generated in response to the payment authentication request and including the user identifier and a user device identifier.

The first decryption module 714 is configured to decrypt the encrypted payment certification information.

The certification processing module 716 is configured to certify whether there is a binding relationship between the user identifier and the user device identifier.

The sending module 710 is further configured to send the certification result to the onboard terminal.

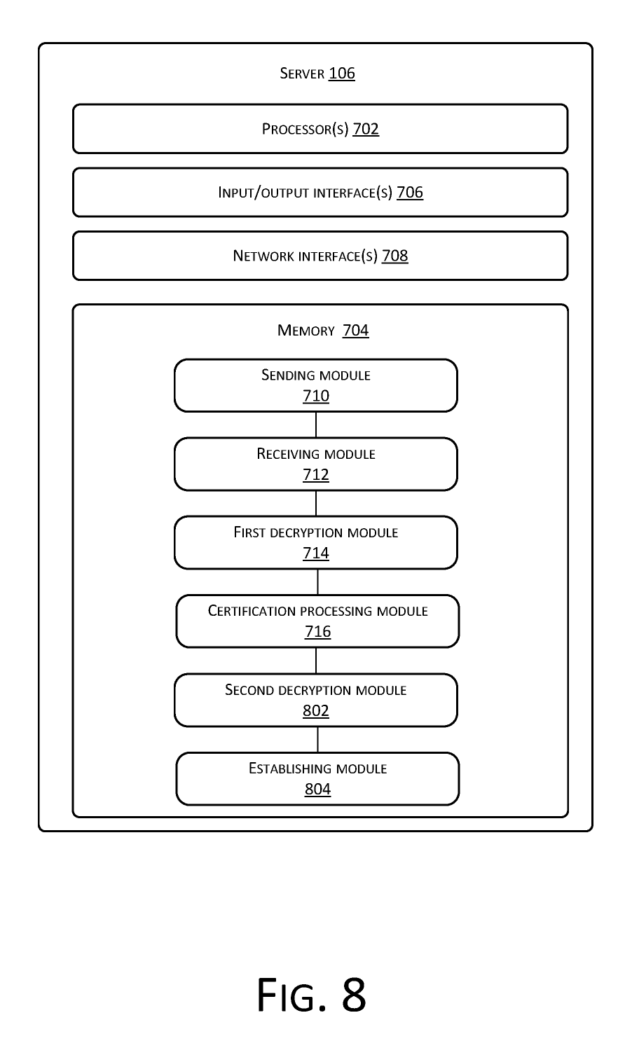

In another example embodiment of the present disclosure, referring to FIG. 8, another structural block diagram of a server for onboard terminal payment authentication according to Example embodiment 4 of the present disclosure is shown. The receiving module 712 is further configured to receive the encrypted user device identifier and the encrypted user identifier which are sent by the onboard terminal 102. The server 106 in this example embodiment further includes a second decryption module 802 and an establishing module 804 stored in the memory 704.

The second decryption module 802 is configured to decrypt the encrypted user device identifier and the encrypted user identifier.

The establishing module 804 is configured to establish a binding relationship between the user device identifier and the user identifier.

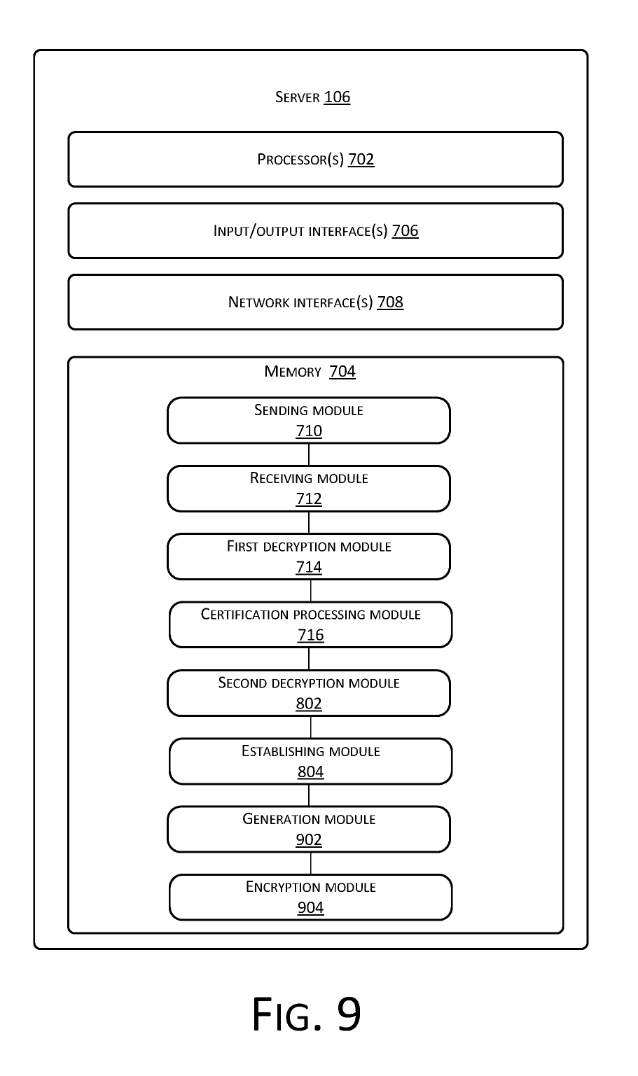

Moreover, in another example embodiment of the present disclosure, referring to FIG. 9, still another structural block diagram of a server for onboard terminal payment authentication according to Example embodiment 4 of the present disclosure is shown. The server 106 in this example embodiment further includes a generation module 902 and an encryption module 904 stored in the memory 704.

The generation module 902 is configured to generate a private key certificate according to the user device identifier and the user identifier.

The encryption module 904 is configured to encrypt the private key certificate.

The sending module 710 is further configured to send the encrypted private key certificate to the onboard terminal, so that the onboard terminal obtains the private key certificate by decryption and sends the private key certificate to the user device.

The encrypted payment certification information is obtained by the user device by encrypting the payment certification information using a private key certificate, wherein the payment certification information is generated by the user device in response to the payment authentication request.

An apparatus example embodiment of a server for onboard terminal payment authentication is described above. The server for onboard terminal payment authentication is further described in the following in combination with the process example embodiment that may be performed at the server 106.

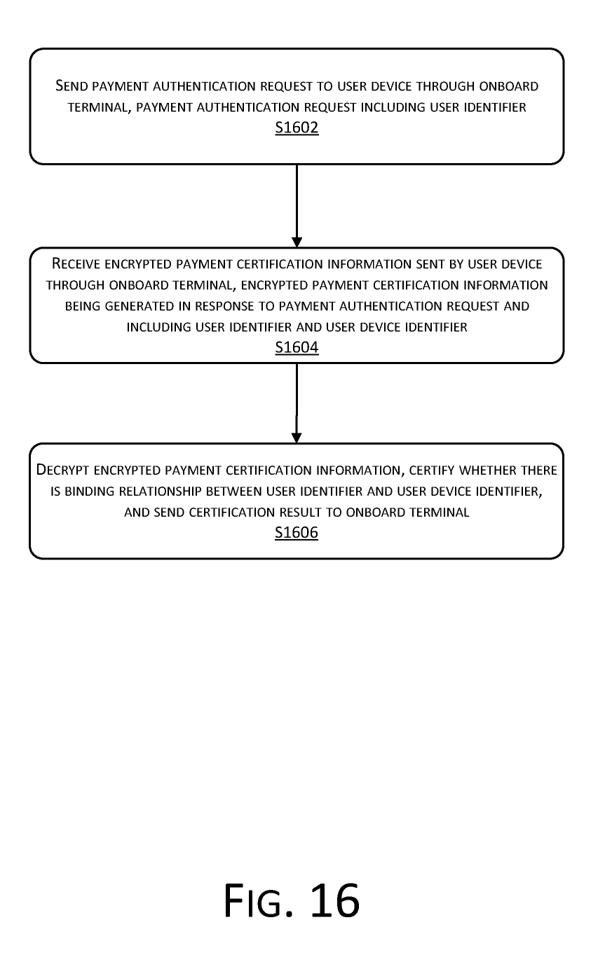

Referring to FIG. 16 to FIG. 18, method flowcharts of a payment authentication method for an onboard terminal performed at the server 106 according to this example embodiment are shown respectively.

Referring to FIG. 16, the payment authentication method that may be performed at the server 106 includes the following steps:

Step S1602: A payment authentication request is sent to a user device through an onboard terminal, the payment authentication request including a user identifier.

Step S1604: Encrypted payment certification information sent by the user device through the onboard terminal is received, the encrypted payment certification information being generated in response to the payment authentication request and including the user identifier and a user device identifier.

Step S1606: The encrypted payment certification information is decrypted, it is certified whether there is a binding relationship between the user identifier and the user device identifier, and a certification result is sent to the onboard terminal.

For example, in step S1602, the sending module 710 sends a payment authentication request to a user device through an onboard terminal, the payment authentication request including a user identifier. Here, the server 106 receives transaction information sent by the onboard terminal, confirms the transaction information, and generates a payment authentication request. Then, the sending module 710 sends the payment authentication request to a user device through the onboard terminal. It should be noted that the onboard terminal has a passthrough function in the process that the server transmits the payment authentication request to the user device.

Following step S1602 as described above, in step S1604, the receiving module 712 receives encrypted payment certification information sent by the user device through the onboard terminal, the encrypted payment certification information being generated in response to the payment authentication request and including the user identifier and a user device identifier. The encrypted payment certification information is obtained by the user device by encrypting the payment certification information using a private key certificate, wherein the payment certification information is generated by the user device in response to the payment authentication request. For example, after receiving the payment authentication request, the user device generates the payment certification information in response to the payment authentication request. Here, the payment authentication request only includes the user identifier, and the user device needs to call its own driver to acquire its own user device identifier, and then generate the payment certification information. That is, the payment certification information includes the user identifier and the user device identifier. After the payment certification information is acquired, a private key certificate stored in a trusted environment of the user device is called to encrypt the payment certification information, the encrypted payment certification information is acquired, and the encrypted payment certification information certainly includes the user identifier and the user device identifier. After acquiring the encrypted payment certification information, the user device first transmits the encrypted payment certification information to the onboard terminal, and then transmits the encrypted payment certification information to the server 106 through the onboard terminal. Here, the onboard terminal also has a passthrough function, that is, the receiving module 712 receives encrypted payment certification information sent by the user device through the onboard terminal, the encrypted payment certification information being generated in response to the payment authentication request. So far, step S1604 has been completed.

Following step S1604 as described above, in step S1606, the first decryption module 714 decrypts the encrypted payment certification information. The certification processing module 716 certifies whether there is a binding relationship between the user identifier and the user device identifier. For example, after the server 106 receives the encrypted payment certification information, first of all, the first decryption module 714 decrypts the encrypted payment certification information. Here, a public key for decrypting the encrypted payment certification information is stored in the server 106. That is, the above description is based on a situation where a private key certificate of the user device is stored in the server 106. As for the situation where the private key certificate of the user device is not stored in the server 106, the example method for acquiring the private key certificate in the server 106 will be given in the following. The first decryption module 714 decrypts the encrypted payment certification information to acquire the user identifier and the user device identifier in the encrypted payment certification information. After the user identifier and the user device identifier are acquired, the certification processing module 716 needs to certify a binding relationship between the user identifier and the user device identifier. For example, the user identifier and the user device identifier may be mapped and compared with user identifiers and user device identifiers that have been kept on record in a database of the server. If the user identifier and the user device identifier exist in the database of the server, and the user identifier and the user device identifier are also mapped in pair, it indicates that there is a binding relationship between the user identifier and the user device identifier. If the user identifier and the user device identifier does not exist in the database of the server, or the user identifier and the user device identifier are not mapped in pair, it indicates that there is no binding relationship between the user identifier and the user device identifier.

When there is no binding relationship between the user identifier and the user device identifier, the server sends a result of failed certification. The sending module 710 sends the result of failed certification to the onboard terminal, and the onboard terminal 102 refuses to perform payment processing according to the result of failed certification, that is, the authentication fails.

When there is a binding relationship between the user identifier and the user device identifier, the server sends a result of successful certification. The sending module 710 sends the result of successful certification to the onboard terminal, and the onboard terminal 102 allows performing payment processing according to the result of successful certification, that is, the authentication is successful. So far, step S1606 has been completed.

The above describes the situation where a binding relationship between the user device identifier and the user identifier is stored in the server, that is, there is no need to establish a binding relationship between the user device identifier and the user identifier in the server in the above authentication process. The situation where a binding relationship between the user device identifier and the user identifier needs to be established in the server in the authentication process is described in detail below:

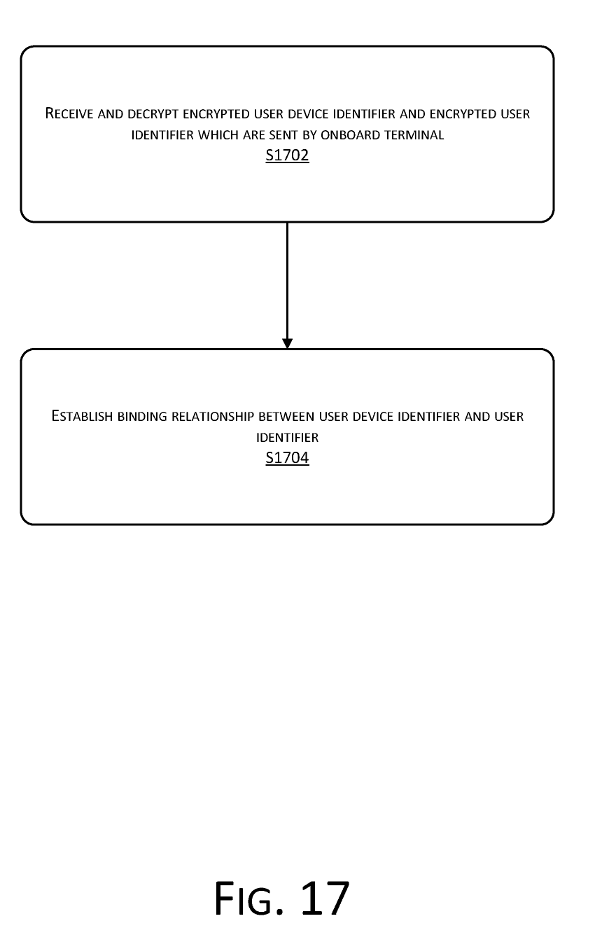

Referring to FIG. 17, a payment authentication method for an onboard terminal performed at the server 106 further includes the following steps:

Step S1702: The encrypted user device identifier and the encrypted user identifier which are sent by the onboard terminal are received and decrypted.

Step S1704: A binding relationship between the user device identifier and the user identifier is established.

For example, in step S1702, the second decryption module 802 decrypts the encrypted user device identifier and the encrypted user identifier. Here, the user device binds to the onboard terminal to transmit its own user device identifier to the onboard terminal. The onboard terminal calls an application API to acquire a user identifier, and encrypts the user identifier and the user device identifier using a public key of the server 106 pre-stored in the onboard terminal 102. The public key of the server 106 may be preset when the onboard terminal 102 leaves the factory. After receiving the encrypted user device identifier and the encrypted user identifier which are sent by the onboard terminal 102, the server 106 decrypts the encrypted user device identifier and the encrypted user identifier using its own private key, and acquires the user device identifier and the user identifier. So far, step S1702 has been completed.

Following step S1702 as described above, in step S1704, the establishing module 804 establishes a binding relationship between the user device identifier and the user identifier. For example, the establishing module 804 makes a backup at the server 106 using the user device identifier and the user identifier acquired by the decryption module 350, that is, establishes a binding relationship between the user device identifier and the user identifier in the server 106. So far, step S1704 has been completed.

The process that the server 106 establishes a binding relationship between the user device identifier and the user identifier is described above.

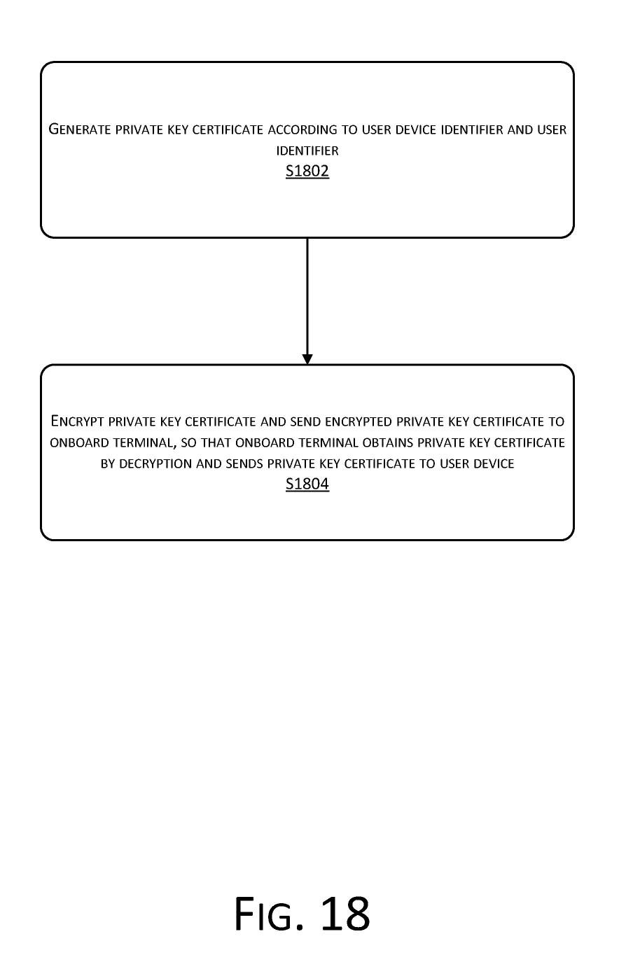

In addition, referring to FIG. 18, after step S1704 of establishing a binding relationship between the user device identifier and the user identifier, the method further includes the following steps:

Step S1802: A private key certificate is generated according to the user device identifier and the user identifier.

Step S1804: The private key certificate is encrypted and sent to the onboard terminal, so that the onboard terminal obtains the private key certificate by decryption and sends the private key certificate to the user device.

For example, in step S1802, the generation module 902 generates a private key certificate according to the user device identifier and the user identifier. For example, after the user device identifier and the user identifier are acquired, the generation module 902 generates a private key certificate using the user device identifier and the user identifier, that is, the private key certificate stored in the user device 10 and the server 106. After the private key certificate is acquired, the private key certificate first needs to be stored and backed up in the server 106 for decryption, and then the private key certificate needs to be transmitted to the user device through the onboard terminal (as in the following step). So far, step S1802 has been completed.

Following step S1802 as described above, in step S1804, first of all, the encryption module 904 encrypts the private key certificate. Then, the sending module 710 sends the encrypted private key certificate to the onboard terminal, so that the onboard terminal obtains the private key certificate by decryption, and sends the private key certificate to the user device. For example, the encryption module 904 encrypts the private key certificate using a public key of the onboard terminal 102. Here, the public key of the onboard terminal 102 may be acquired by the server 106 by accessing the onboard terminal 102 via a communication network.

After the private key certificate is encrypted, the sending module 710 sends the encrypted private key certificate to the onboard terminal, so that the onboard terminal obtains the private key certificate by decryption, and sends the private key certificate to the user device. For example, the sending module 710 sends the encrypted private key certificate to the onboard terminal, and after acquiring the encrypted private key certificate, the onboard terminal 102 decrypts the encrypted private key certificate using a private key corresponding to the public key of the onboard terminal 102 to acquire the private key certificate, and then sends the private key certificate to the user device to allow the user device to store the private key certificate in a trusted environment for use in encryption of the payment certification information. So far, step S1804 has been completed.

The process that the server 106 acquires the private key certificate is described above.

It should be noted that reference may be made to the method in Example embodiment 2 for the method for acquiring the private key certificate of the user device, and reference may be made to the content in Example embodiment 2 for any unclear content in this example embodiment.

In addition, in the payment authentication method and apparatus for an onboard terminal according to the example embodiments of the present disclosure, the onboard terminal 102, the user device 104, the server 106 and their execution methods are dependent upon each other and interact with each other. Reference may be made to each other for any unclear content in the foregoing example embodiments.

### Example Embodiment 5

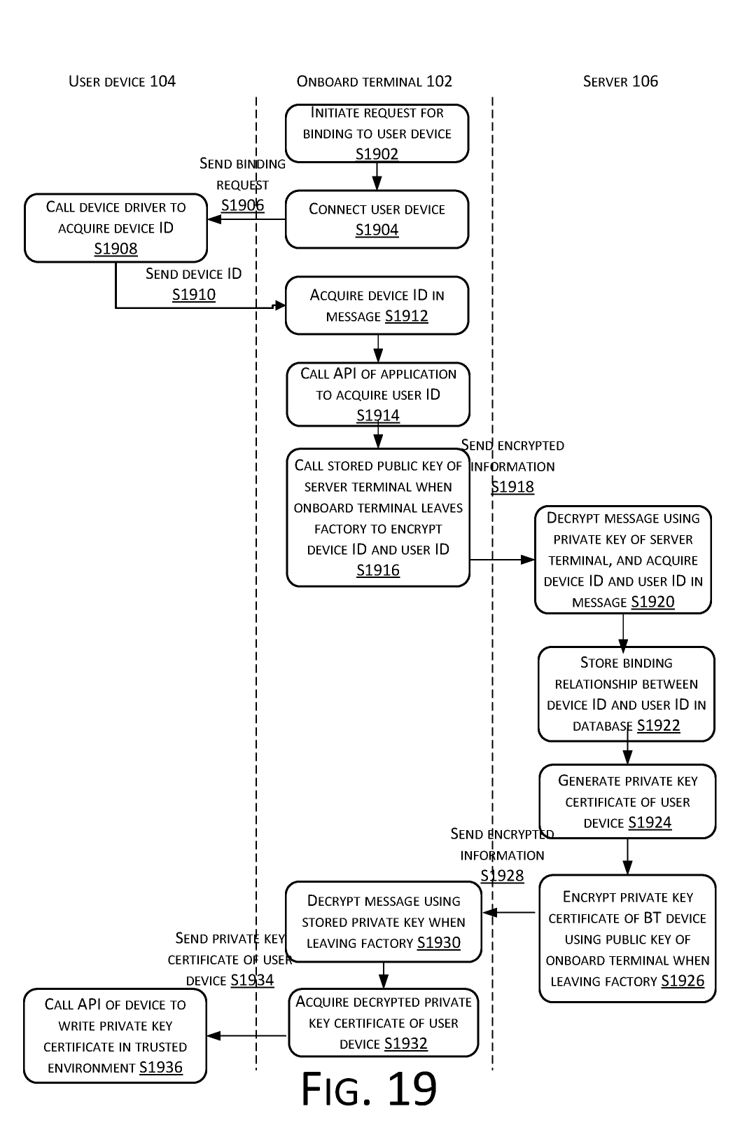

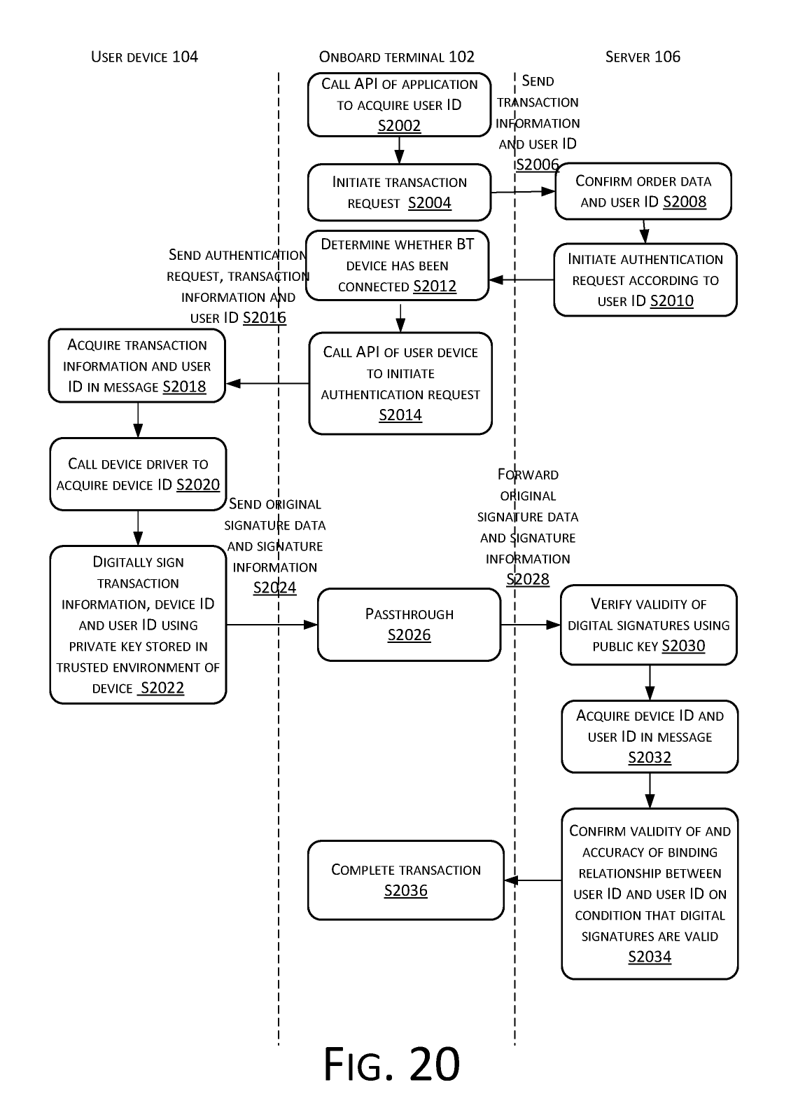

Referring to FIG. 19 and FIG. 20, operational schematic diagrams of a payment authentication system according to Example embodiment 5 of the present disclosure are shown respectively.

FIG. 19 is an operational schematic diagram showing that the server 106 establishes the user device identifier and the user identifier and acquires a private key certificate. FIG. 20 is an operational schematic diagram of authentication on a payment transaction.

First of all, as shown in FIG. 19, the payment authentication system 100 may perform the following operation steps:

Step S1902: An onboard terminal 102 initiates a request for binding to a user device 104.

Step S1904: The onboard terminal 102 calls an API interface of the user device 104 to connect the user device 104.

Step S1906: The onboard terminal 102 sends a binding request to the user device 104.

Step S1908: The user device 104 calls a device driver to acquire its own device ID.

Step S1910: The user device 104 sends the device ID to the onboard terminal 102.

Step S1912: The onboard terminal 102 acquires a device ID in a message.

Step S1914: The onboard terminal 102 calls an API interface of an application to acquire a user ID logged in to an application.

Step S1916: The onboard terminal 102 calls a public key of a server 106 stored when leaving the factory to encrypt the device ID and the user ID.

Step S1918: The onboard terminal 102 sends encrypted information to the server 106.

Step S1920: The server 106 decrypts the message using a private key of a server terminal, and acquires the device ID and the user ID in the message.

Step S1922: The server 106 stores a binding relationship between the device ID and the user ID in a database.

Step S1924: The server 106 generates a private key certificate of the user device 104.

Step S1926: The server 106 encrypts the private key certificate of the user device 104 using public key data in a public-private key pair written when the onboard terminal 102 leaves the factory.

Step S1928: The server 106 sends the encrypted information to the onboard terminal 102.

Step S1930: The onboard terminal 102 decrypts the message using a stored private key when the onboard terminal 102 leaves the factory.

Step S1932: The onboard terminal 102 acquires the decrypted private key certificate of the user device 104 in the decrypted message.

Step S1934: The onboard terminal 102 sends the private key certificate of the user device 104 to the user device 104 through an API interface of the user device 104.

Step S1936: The user device 104 calls the API interface of the device to write the private key certificate in a trusted environment of the device, to bind the user device 104 to the onboard terminal 102 and write the private key certificate of the user device 104.

By performing the above operations, the payment authentication system 100 acquires the private key certificate of the user device 104, and stores the private key certificate of the user device 104 in a trusted environment of a storage module of the user device 104.

Secondly, as shown in FIG. 20, the payment authentication system 100 may further perform the following operation steps:

Step S2002: The onboard terminal 102 calls an API of an application to acquire a user ID through which a user logs in to the application.

Step S2004: The onboard terminal 102 initiates a transaction request according to order information of the user.

Step S2006: The onboard terminal 102 sends transaction information and the user ID to the server 106.

Step S2008: The server 106 confirms order data in the transaction information and the user ID.

Step S2010: The server 106 initiates an authentication request to the onboard terminal 102 according to the user ID.

Step S2012: After receiving the authentication request, the onboard terminal 102 first determines whether the user device 104 has been connected.

Step S2014: If the user device 104 has been connected, the onboard terminal 102 calls an API interface of the user device 104 to initiate an authentication request.

Step S2016: The onboard terminal 102 sends information of the authentication request, the transaction information and the user ID to the user device 104.

Step S2018: The user device 104 acquires and parses the transaction information and the user ID in a message.

Step S2020: The user device 104 calls a device driver to acquire its own device ID.

Step S2022: The user device 104 digitally signs the transaction information, the device ID and the user ID using a private key stored in a trusted environment of the device.

Step S2024: The user device 104 sends digital signature results and original signature data together to the onboard terminal 102.

Step S2026: The onboard terminal 102 adopts a manner of passthrough, and does not process the data sent by the user device 104.

Step S2028: The onboard terminal 102 forwards to the server 106 the signature results and the original signature data which are sent by the user device 104.

Step S2030: The server 106 verifies the validity of the digital signatures of the user device 104 using a public key.

Step S2032: After the digital signatures are verified successfully, the server 106 acquires and parses the device ID and the user ID in the message.

Step S2034: The server 106 confirms the validity of the device ID and the user ID and the accuracy of the binding relationship between the device ID and the user ID, and sends a transaction result to the onboard terminal 102 on the condition that the digital signatures are valid.

Step S2036: The onboard terminal 102 confirms completion of the transaction.

By performing the above operations, the payment authentication system 100 completes a payment authentication transaction through the user device 104, the onboard terminal 102 and the server 106.

According to the payment authentication system for an onboard terminal in the present disclosure, through the payment authentication system consisting of a user device and a server connected to an onboard terminal, an ID of the user device and a user identifier of the onboard terminal are acquired, the user device identifier and the user identifier are encrypted in the onboard terminal, an encrypted file is transmitted to the server, the encrypted file is decrypted in the server to generate a private key certificate of the user device, and the private key certificate is encrypted and then transmitted to the onboard terminal. The private key certificate is decrypted in the onboard terminal, the decrypted private key certificate is stored in a trusted environment of the user device, and the private key certificate of the user device is called to digitally sign the transaction information, the user identifier and the user device identifier during a payment transaction. A digital signature file is sent to the server through the onboard terminal to allow the server to acquire the user identifier and the user device identifier when the digital signature file is valid, and the validity of and the binding relationship between the user identifier and the user device identifier are confirmed to complete the transaction information. The problem of a complicated payment process and poor payment security in an existing mobile payment technology applied to onboard terminals is solved. All files are transmitted in an encrypted manner in the process of acquiring the private key certificate, which improves the security of payment authentication. In the payment process of the onboard terminal, it is unnecessary for a motor vehicle driver to perform excessive operations, and the payment process is simple, thus guaranteeing the driver's safety and improving user's payment experience.

The above descriptions show and describe several example embodiments of the present disclosure. However, as described previously, it should be understood that the present disclosure is not limited to the form disclosed in this text, should not be regarded as excluding other example embodiments, but may be applied to various other combinations, modifications and environments, and may be altered within the scope of the invention conception in this text through the above teachings or technologies or knowledge in related fields. The alterations and changes that made by those skilled in the art and do not depart from the spirit and scope of the present disclosure should all fall within the protection scope of the appended claims of the present disclosure.

The present disclosure may further be understood with clauses as follows.

Clause 1. A payment authentication method for an onboard terminal comprising:

receiving a payment authentication request sent by a server, and forwarding the payment authentication request to a user device having an established communication connection, the payment authentication request comprising a user identifier;

receiving encrypted payment certification information responded by the user device and sending the encrypted payment certification information to the server, the encrypted payment certification information comprising the user identifier and a user device identifier; and receiving a certification result sent by the server and performing payment processing according to the certification result, the certification result indicating whether there is a binding relationship between the user identifier and the user device identifier.

Clause 2. The method of clause 1, further comprising:

acquiring the user device identifier, and encrypting the user device identifier and the user identifier; and

sending the encrypted user device identifier and the encrypted user identifier to the server, so that the server establishes the binding relationship between the user device identifier and the user identifier.

Clause 3. The method of clause 2, wherein the acquiring the user device identifier comprises:

sending a binding request to the user device; and

receiving a binding response sent by the user device, the binding response comprising the user device identifier.

Clause 4. The method of clause 2, wherein the encrypted payment certification information is obtained by the user device by encrypting payment certification information using a private key certificate, wherein the payment certification information is generated by the user device in response to the payment authentication request.

Clause 5. The method of clause 4, after the sending the encrypted user device identifier and the encrypted user identifier to the server, further comprising:

receiving the private key certificate encrypted and sent by the server, the private key certificate being generated by the server according to the user device identifier and the user identifier; and

obtaining the private key certificate by decryption, and sending the private key certificate to the user device.

Clause 6. A payment authentication method for an onboard terminal comprising:

receiving a payment authentication request sent by an onboard terminal having an established communication connection, the payment authentication request comprising a user identifier;

generating encrypted payment certification information in response to the payment authentication request, the encrypted payment certification information comprising the user identifier and a user device identifier; and sending the encrypted payment certification information to a server through the onboard terminal, so that the server certifies whether there is a binding relationship between the user identifier and the user device identifier.

Clause 7. The method of clause 6, wherein the generating the encrypted payment certification information in response to the payment authentication request comprises:

generating the payment certification information in response to the payment authentication request; and

encrypting the payment certification information using a private key certificate to generate the encrypted payment certification information.

Clause 8. The method of clause 7, further comprising:

receiving a binding request sent by the onboard terminal, and sending the user device identifier to the onboard terminal in response to the binding request to allow the onboard terminal to send the encrypted user device identifier and the encrypted user identifier to the server, so that the server decrypts the encrypted user device identifier and the encrypted user identifier to generate the private key certificate and sends the encrypted private key certificate to the onboard terminal; and

receiving the decrypted private key certificate sent by the onboard terminal.

Clause 9. A payment authentication method for an onboard terminal comprising:

sending a payment authentication request to a user device through an onboard terminal, the payment authentication request comprising a user identifier;

receiving encrypted payment certification information sent by the user device through the onboard terminal, the encrypted payment certification information being generated in response to the payment authentication request and comprising the user identifier and a user device identifier; and

decrypting the encrypted payment certification information, certifying whether there is a binding relationship between the user identifier and the user device identifier, and sending the certification result to the onboard terminal.

Clause 10. The method of clause 9, further comprising:

receiving and decrypting the encrypted user device identifier and the encrypted user identifier that are sent by the onboard terminal; and

establishing the binding relationship between the user device identifier and the user identifier.

Clause 11. The method of clause 10, wherein the encrypted payment certification information is obtained by the user device by encrypting the payment certification information using a private key certificate, wherein the payment certification information is generated by the user device in response to the payment authentication request.

Clause 12. The method of clause 11, after the establishing the binding relationship between the user device identifier and the user identifier, further comprising:

generating a private key certificate according to the user device identifier and the user identifier; and

encrypting the private key certificate and sending the encrypted private key certificate to the onboard terminal, so that the onboard terminal obtains the private key certificate by decryption and sends the private key certificate to the user device.

Clause 13. An onboard terminal for onboard terminal payment authentication comprising:

a first communication module configured to receive a payment authentication request sent by a server, the payment authentication request comprising a user identifier;

a second communication module configured to forward the payment authentication request to a user device having an established communication connection; and receive encrypted payment certification information responded by the user device, the encrypted payment certification information comprising the user identifier and a user device identifier;

the first communication module further configured to send the encrypted payment certification information to the server; and receive a certification result sent by the server, the certification result indicating whether there is a binding relationship between the user identifier and the user device identifier; and

a processing module configured to perform payment processing according to the certification result.

Clause 14. The onboard terminal of clause 13, further comprising:

an acquiring module configured to acquire the user device identifier;

an encryption module configured to encrypt the user device identifier and the user identifier; and

the first communication module further configured to send the encrypted user device identifier and the encrypted user identifier to the server, so that the server establishes the binding relationship between the user device identifier and the user identifier.

Clause 15. The onboard terminal of clause 14, wherein the acquiring module is specifically configured to:

send a binding request to the user device through the second communication module; and

receive, through the second communication module, a binding response sent by the user device, the binding response comprising the user device identifier.

Clause 16. The onboard terminal of clause 14, wherein the encrypted payment certification information is obtained by the user device by encrypting payment certification information using a private key certificate, wherein the payment certification information is generated by the user device in response to the payment authentication request.

Clause 17. The onboard terminal of clause 16, wherein the first communication module is further configured to receive the private key certificate encrypted and sent by the server, the private key certificate being generated by the server according to the user device identifier and the user identifier; and

the onboard terminal further comprises:

a decryption module configured to obtain the private key certificate by decryption; and

the second communication module further configured to send the private key certificate to the user device.

Clause 18. A user device for onboard terminal payment authentication comprising:

a receiving module configured to receive a payment authentication request sent by an onboard terminal having an established communication connection, the payment authentication request comprising a user identifier;

a generation module configured to generate encrypted payment certification information in response to the payment authentication request, the encrypted payment certification information comprising the user identifier and a user device identifier; and

a sending module configured to send the encrypted payment certification information to a server through the onboard terminal, so that the server certifies whether there is a binding relationship between the user identifier and the user device identifier.

Clause 19. The user device of clause 18, wherein the generation module comprises:

a generation unit configured to generate payment certification information in response to the payment authentication request; and

an encryption unit configured to encrypt the payment certification information using a private key certificate to generate the encrypted payment certification information.

Clause 20. The user device of clause 19, wherein:

the receiving module is further configured to receive a binding request sent by the onboard terminal;

the sending module is further configured to send the user device identifier to the onboard terminal in response to the binding request to allow the onboard terminal to send the encrypted user device identifier and the encrypted user identifier to the server, so that the server decrypts the encrypted user device identifier and the encrypted user identifier to generate the private key certificate and sends the encrypted private key certificate to the onboard terminal; and

the receiving module is further configured to receive the decrypted private key certificate sent by the onboard terminal.

Clause 21. A server for onboard terminal payment authentication comprising:

a sending module configured to send a payment authentication request to a user device through an onboard terminal, the payment authentication request comprising a user identifier;

a receiving module configured to receive encrypted payment certification information sent by the user device through the onboard terminal, the encrypted payment certification information being generated in response to the payment authentication request and comprising the user identifier and a user device identifier;

a first decryption module configured to decrypt the encrypted payment certification information;

a certification processing module configured to certify whether there is a binding relationship between the user identifier and the user device identifier; and

the sending module further configured to send the certification result to the onboard terminal.

Clause 22. The server of clause 21, wherein:

the receiving module is further configured to receive the encrypted user device identifier and the encrypted user identifier that are sent by the onboard terminal; and

the server further comprises:

a second decryption module configured to decrypt the encrypted user device identifier and the encrypted user identifier; and

an establishing module configured to establish a binding relationship between the user device identifier and the user identifier.

Clause 23. The server of clause 22, wherein the encrypted payment certification information is obtained by the user device by encrypting the payment certification information using a private key certificate, wherein the payment certification information is generated by the user device in response to the payment authentication request.

Clause 24. The server of clause 23, further comprising:

a generation module configured to generate a private key certificate according to the user device identifier and the user identifier;

an encryption module configured to encrypt the private key certificate; and

the sending module further configured to send the encrypted private key certificate to the onboard terminal, so that the onboard terminal obtains the private key certificate by decryption and sends the private key certificate to the user device.

Clause 25. A system for onboard terminal payment authentication comprising:

an onboard terminal of any of clauses 13 to 17;

a user device of any of clauses 18 to 20; and

a server of any of clauses 21 to 24.

What is claimed is:

1. A method comprising:
receiving, by an onboard terminal, a payment authentication request sent by a server;
forwarding the payment authentication request to a user device, the payment authentication request including a user identifier;
receiving encrypted payment certification information responded by the user device;
sending the encrypted payment certification information to the server, the encrypted payment certification information including the user identifier and a user device identifier;
receiving a certification result sent by the server; and
performing payment processing according to the certification result.

2. The method of claim 1, wherein the user device has established a communication with the onboard terminal.

3. The method of claim 1, wherein the certification result indicates whether there is a binding relationship between the user identifier and the user device identifier.

4. The method of claim 1, further comprising:
acquiring the user device identifier;
encrypting the user device identifier and the user identifier; and
sending the encrypted user device identifier and the encrypted user identifier to the server.

5. The method of claim 4, further comprising requesting the server to establish a binding relationship between the user device identifier and the user identifier.

6. The method of claim 4, wherein the acquiring the user device identifier comprises:
sending a binding request to the user device; and
receiving a binding response sent by the user device.

7. The method of claim 6, wherein the binding response includes the user device identifier.

8. The method of claim 1, wherein the encrypted payment certification information is obtained by the user device by encrypting payment certification information using a private key certificate.

9. The method of claim 1, wherein the payment certification information is generated by the user device in response to the payment authentication request.

10. The method of claim 4, further comprising:
after the sending the encrypted user device identifier and the encrypted user identifier to the server,
receiving the private key certificate encrypted and sent by the server, the private key certificate being generated by the server according to the user device identifier and the user identifier;
obtaining the private key certificate by decryption; and
sending the private key certificate to the user device.

11. A device comprising:
one or more processors; and
one or more computer storage media storing thereon computer-readable instructions that, when executed by the one or more processors, cause the one or more processors to perform acts comprising:
receiving a payment authentication request sent by an onboard terminal, the payment authentication request including a user identifier;
generating encrypted payment certification information in response to the payment authentication request, the encrypted payment certification information including the user identifier and a user device identifier; and
sending the encrypted payment certification information to a server through the onboard terminal.

12. The device of claim 11, wherein the onboard terminal has established a communication.

13. The device of claim 11, wherein the acts further comprise requesting the server to certify whether there is a binding relationship between the user identifier and the user device identifier.

14. The device of claim 11, wherein the generating the encrypted payment certification information in response to the payment authentication request includes:
generating the payment certification information in response to the payment authentication request; and
encrypting the payment certification information using a private key certificate to generate the encrypted payment certification information.

15. The device of claim 14, wherein the acts further comprise:
receiving a binding request sent by the onboard terminal;
sending the user device identifier to the onboard terminal in response to the binding request to allow the onboard terminal to send the encrypted user device identifier and the encrypted user identifier to the server; and
receiving the decrypted private key certificate sent by the onboard terminal.

16. The device of claim 15, wherein the acts further comprise requesting the server to decrypt the encrypted user device identifier and the encrypted user identifier to generate the private key certificate and send the encrypted private key certificate to the onboard terminal.

17. One or more memories storing thereon computer-readable instructions that, when executed by one or more processors, cause the one or more processors to perform acts comprising:
sending a payment authentication request to a user device through an onboard terminal, the payment authentication request including a user identifier;
receiving encrypted payment certification information sent by the user device through the onboard terminal, the encrypted payment certification information including the user identifier and a user device identifier;
decrypting the encrypted payment certification information;
certifying that there is a binding relationship between the user identifier and the user device identifier; and
sending the certification result to the onboard terminal.

18. The one or more memories of claim 17, wherein the acts further comprise:
receiving and decrypting the encrypted user device identifier and the encrypted user identifier that are sent by the onboard terminal; and
establishing the binding relationship between the user device identifier and the user identifier.

19. The one or more memories of claim 18, wherein:
the encrypted payment certification information is obtained by the user device by encrypting the payment certification information using a private key certificate; and
the payment certification information is generated by the user device in response to the payment authentication request.

20. The one or more memories of claim 18, wherein the acts further comprise:
after the establishing the binding relationship between the user device identifier and the user identifier,
generating a private key certificate according to the user device identifier and the user identifier;
encrypting the private key certificate; and
sending the encrypted private key certificate to the onboard terminal, so that the onboard terminal obtains the private key certificate by decryption and sends the private key certificate to the user device.
